(19) United States
(12) Patent Application Publication
(10) Pub. No.: US 2024/0234059 A1
(43) Pub. Date: Jul. 11, 2024

(54) VACUUM INTERRUPTER

(71) Applicant: Mitsubishi Electric Corporation, Chiyoda-ku Tokyo (JP)

(72) Inventor: Masashi KAWADA, Chiyoda-ku, Tokyo (JP)

(73) Assignee: Mitsubishi Electric Corporation, Chiyoda-ku Tokyo (JP)

(21) Appl. No.: 18/559,137

(22) PCT Filed: Jan. 28, 2022
(86) PCT No.: PCT/JP2022/003316

§ 371 Date: Nov. 6, 2023

(30) Foreign Application Priority Data
Jun. 29, 2021 (JP) 2021-107242

(51) Int. Cl. H01H 33/664; H01H 33/662

(52) U.S. Cl. CPC H01H 33/664; H01H 33/66207

(57) ABSTRACT

A fixed side power feeding plate having a fixed side circular arc shaped power feeding portion, a fixed side coil electrode having a fixed side circular arc shaped coil portion, a movable side power feeding plate having a movable side circular arc shaped power feeding portion, wherein a fixed side cavity is formed between a fixed side contact and the fixed side circular arc shaped power feeding portion, a movable side cavity is formed between a movable side contact and the movable side circular arc shaped power feeding portion, a fixed side air gap is formed between the fixed side circular arc shaped coil portion and the fixed side circular arc shaped power feeding portion, and a movable side air gap is formed between the movable side circular arc shaped coil portion and the movable side circular arc shaped power feeding portion.

### TECHNICAL FIELD

The present application relates to a vacuum interrupter.

### BACKGROUND ART

In a known a vacuum interrupter, a fixed side flange and a movable side flange are each fixed on both ends of an insulation cylinder by brazing; and a fixed side energization rod and a movable side energization rod are attached respectively to the fixed side flange and the movable side flange. A contact is fixed to each end portion of the fixed side energization rod and the movable side energization rod; and a coil electrode in which an axial magnetic field is generated during energization is provided on the rear surface side of the contact.

The coil electrode has a plurality of circular arc shaped coil portions; and a convex portion (power feeding portion) formed on the coil portion is connected to the contact. By having such a coil portion, an axial magnetic field is generated by a current flowing in the coil portion via the power feeding portion during energization and current interruption is efficiently performed.

### RELATED ART DOCUMENT

### Patent Document

Patent Document 1: JP-A-2002-150902

### SUMMARY OF THE INVENTION

### Problems to be Solved by the Invention

In the above known vacuum interrupter, the fixed side power feeding portion is provided on the fixed side coil electrode and the movable side power feeding portion is provided on the movable side coil electrode to flow a current between the fixed side coil electrode and the fixed side contact or between the movable side coil electrode and the movable side contact. In a contact surface, as an area in which an axial magnetic field having necessary magnetic flux density is generated, the area being referred to as an effective magnetic field area, is wide, current density in the contact surface can be reduced and it becomes possible to interrupt the current more effectively. However, a magnetic field cannot be generated in an axial direction by the fixed side power feeding portion provided on the fixed side coil electrode and by the movable side power feeding portion provided on the movable side coil electrode; accordingly, a problem exists in that the effective magnetic field area is lost.

The present application is to disclose a technique for solving the foregoing problem and an object of the present application is to provide a vacuum interrupter which can secure an effective magnetic field area and can improve current interrupting performance.

### Means for Solving the Problems

A vacuum interrupter disclosed in the present application is a vacuum interrupter which includes: a cylindrical insulation container, a fixed side electrode arranged in the inside of the insulation container, and a movable side electrode which is arranged in the inside of the insulation container and is brought into contact with and separated from the fixed side electrode. In the vacuum interrupter, the fixed side electrode and the movable side electrode each have a contact; at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and a cavity is formed between the contact and the circular arc shaped power feeding portion, and an air gap is formed between the circular arc shaped coil portion and the circular arc shaped power feeding portion.

Furthermore, a vacuum interrupter disclosed in the present application is a vacuum interrupter which includes: a cylindrical insulation container, a fixed side electrode arranged in the inside of the insulation container, and a movable side electrode which is arranged in the inside of the insulation container and is brought into contact with and separated from the fixed side electrode. In the vacuum interrupter, the fixed side electrode and the movable side electrode each have a contact; at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and a cavity is formed between the contact and the circular arc shaped power feeding portion, a power feeding plate float portion is formed on the rear surface of the circular arc shaped power feeding portion of the power feeding plate, and a float portion air gap is formed between the power feeding plate float portion and the circular arc shaped coil portion.

Moreover, a vacuum interrupter disclosed in the present application is a vacuum interrupter which includes: a cylindrical insulation container, a fixed side electrode arranged in the inside of the insulation container, and a movable side electrode which is arranged in the inside of the insulation container and is brought into contact with and separated from the fixed side electrode. In the vacuum interrupter, the fixed side electrode and the movable side electrode each have a contact; at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and a cavity is formed between the contact and the circular arc shaped power feeding portion, a circular arc shaped first groove portion is formed on a termination end portion of the circular arc shaped coil portion of the coil electrode, a circular arc shaped second groove portion that is deeper than the depth of the circular arc shaped first groove portion is formed on a beginning end portion of the circular arc shaped coil portion of the coil electrode which sandwiches the slit, the circular arc shaped power feeding portion of the power feeding plate is arranged over the circular arc shaped first groove portion and the circular arc shaped second groove portion, the circular arc shaped power feeding portion of the power feeding plate is fixed to the circular arc shaped first groove portion, and a groove portion air gap is formed between the circular arc shaped power feeding portion of the power feeding plate and the circular arc shaped second groove portion.

Additionally, a vacuum interrupter disclosed in the present application is a vacuum interrupter which includes: a cylindrical insulation container, a fixed side electrode arranged in the inside of the insulation container, and a movable side electrode which is arranged in the inside of the insulation container and is brought into contact with and separated from the fixed side electrode. In the vacuum interrupter, at least either the fixed side electrode or the movable side electrode includes: a contact which has a contact surface that is brought into contact with and separated from other electrode and a rear surface on the opposite side to the contact surface; a coil electrode which is arranged on the rear surface side of the contact and has a circular arc shaped circular arc portion extending in a circumferential direction; and a power feeding plate which has a connection part that is to be connected to the coil electrode and an opposite part that is adjacent to the connection part and is faced to the circular arc portion of the coil electrode via an air gap and in which a surface on the opposite side to the connection part and the opposite part is connected to the contact.

### Advantageous Effect of the Invention

According to the vacuum interrupter disclosed in the present application, there can be obtained a vacuum interrupter which can secure an effective magnetic field area and can improve current interrupting performance.

### BRIEF DESCRIPTION OF THE DRAWINGS

FIG. 1 is a sectional view showing a vacuum interrupter according to Embodiment 1;

FIG. 2 is an exploded perspective view showing an electrode structure in the vacuum interrupter according to Embodiment 1;

FIG. 3 is a front view showing a power feeding plate in the vacuum interrupter according to Embodiment 1;

FIG. 4 is a front view showing a state where a coil electrode and the power feeding plate are fixed in the vacuum interrupter according to Embodiment 1;

FIGS. 5A, 5B are views showing a contact in the vacuum interrupter according to Embodiment 1, FIG. 5A is a rear view, and FIG. 5B is a perspective view;

FIG. 6 is a sectional view showing the electrode structure in the vacuum interrupter according to Embodiment 1;

FIGS. 7A, 7B are views showing a power feeding plate in a vacuum interrupter according to Embodiment 2, FIG. 7A is a front view, and FIG. 7B is a rear view;

FIG. 8 is a sectional view showing an electrode structure in the vacuum interrupter according to Embodiment 2;

FIGS. 9A, 9B, are views showing a power feeding plate in a vacuum interrupter according to Embodiment 3, FIG. 9A is a front view, and FIG. 9B is a rear view;

FIG. 10 is a sectional view showing an electrode structure in the vacuum interrupter according to Embodiment 3;

FIG. 11 is an exploded perspective view showing an electrode structure in a vacuum interrupter according to Embodiment 4;

FIGS. 12A, 12B are views showing a power feeding plate in the vacuum interrupter according to Embodiment 4, FIG. 12A is a rear view, and FIG. 12B is a perspective view;

FIG. 13 is a front view showing a state where a coil electrode and the power feeding plate are fixed in the vacuum interrupter according to Embodiment 4;

FIG. 14 is a sectional view showing an electrode structure in the vacuum interrupter according to Embodiment 4;

FIG. 15 is a front view showing a power feeding plate in a vacuum interrupter according to Embodiment 5;

FIG. 16 is a front view showing a state where a coil electrode and the power feeding plate are fixed in the vacuum interrupter according to Embodiment 5;

FIG. 17 is an exploded perspective view showing an electrode structure in a vacuum interrupter according to Embodiment 6;

FIGS. 18A, 18B are views showing a coil electrode in a vacuum interrupter according to Embodiment 6, FIG. 18A is a front view, and FIG. 18B is a perspective view;

FIG. 19 is a front view showing a state where the coil electrode and a power feeding plate are fixed in the vacuum interrupter according to Embodiment 6; and

FIG. 20 is a sectional view showing the electrode structure in the vacuum interrupter according to Embodiment 6.

### MODE FOR CARRYING OUT THE INVENTION

### Embodiment 1

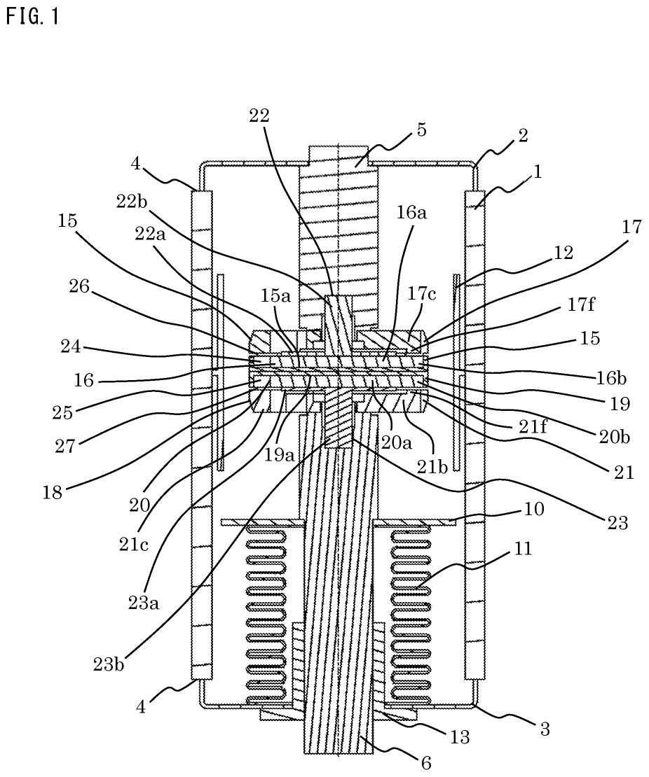

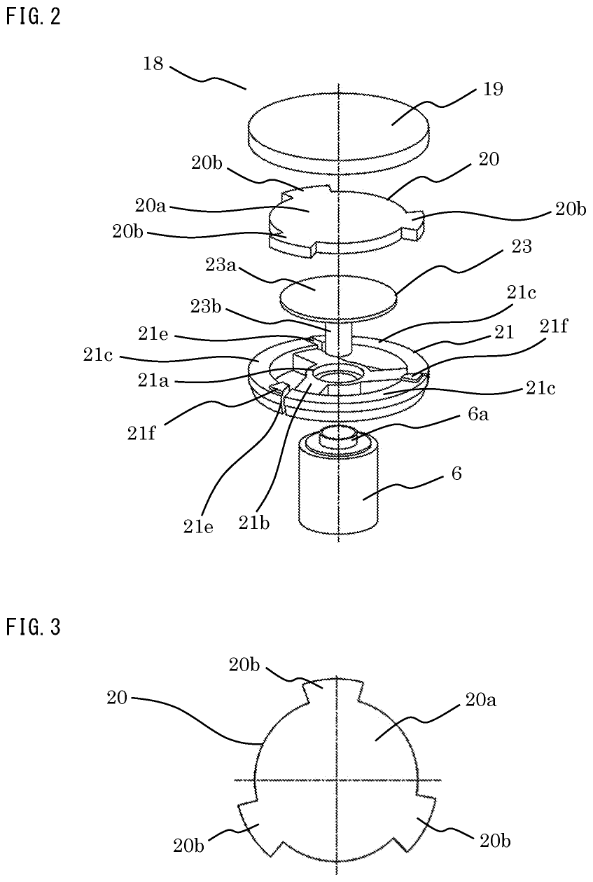

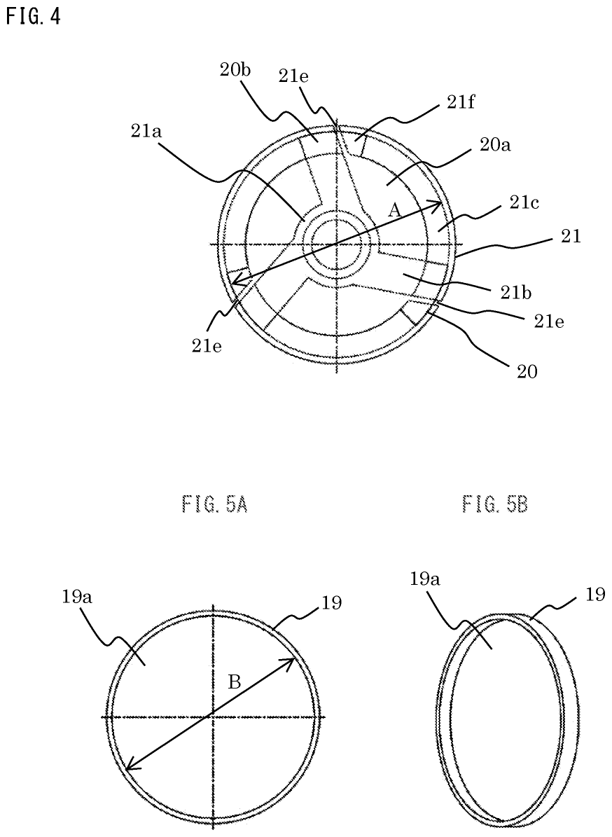

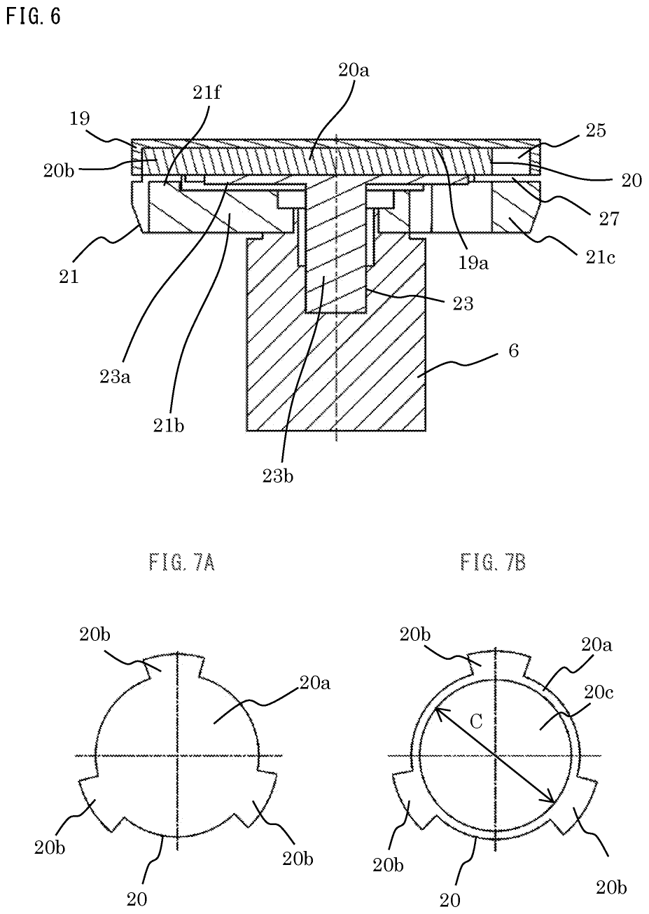

Hereinafter, Embodiment 1 of the present application will be described based on FIG. 1 through FIG. 6; and, in each of the drawings, identical or equivalent members and parts will be described with the same reference numerals (and letters) assigned thereto. FIG. 1 is a sectional view showing a vacuum interrupter according to Embodiment 1. FIG. 2 is an exploded perspective view showing an electrode structure in the vacuum interrupter according to Embodiment 1. FIG. 3 is a front view showing a power feeding plate in the vacuum interrupter according to Embodiment 1. FIG. 4 is a front view showing a state where a coil electrode and the power feeding plate are fixed in the vacuum interrupter according to Embodiment 1. FIGS. 5A, 5B are views showing a contact in the vacuum interrupter according to Embodiment 1, FIG. 5A is a rear view, and FIG. 5B is a perspective view. FIG. 6 is a sectional view showing the electrode structure in the vacuum interrupter according to Embodiment 1.

The present application relates to the vacuum interrupter, which has a fixed side electrode and a movable side electrode which are attached in a contactable and separable manner in the vacuum container, and in which electric arc generated during current interruption is diffused by a magnetic field that is generated by a current flowing in the electrodes.

The vacuum interrupter has a cylindrical insulation cylinder 1 using an insulator such as alumina ceramics, glass, or the like as a material; a fixed side flange 2 and a movable side flange 3, which use metal such as stainless steel or the like as a material, are fixed by vacuum brazing to a metallization layer 4 formed on both ends of the insulation cylinder 1 to form a container and to keep the inside thereof high vacuum and airtight.

A fixed side energization rod 5 is fixed to the fixed side flange 2 fixed to one end of the insulation cylinder 1; and a movable side energization rod 6 is attached to the movable side flange 3 via a bellows 11. The movable side flange 3 is fixed to one end of the bellows 11; and the movable side energization rod 6 is fixed to the other end of the bellows 11 via a bellows cover 10 provided for the purpose of preventing the bellows 11 from being contaminated by the electric arc generated during current interruption.

Furthermore, an electric arc shield 12 is provided in the insulation cylinder 1 so as to surround a fixed side contact 15 and a movable side contact 19 which are faced to each other. In the movable side, a guide 13 having a bearing function for operating smoothly on the axial center in the process of its opening and closing is attached to a movable side end portion.

A fixed side electrode 14 and a movable side electrode 18 are attached respectively to the fixed side energization rod 5 and the movable side energization rod 6 so as to be faced to each other. The fixed side electrode 14 includes: a fixed side contact 15 which is formed in a disk shape and is formed with a fixed side contact back spot facing portion 15a on a back surface; a fixed side power feeding plate 16 which is fixed to the inner surface of the fixed side contact back spot facing portion 15a of the fixed side contact 15 and has a fixed side circular arc shaped power feeding portion 16b arranged evenly, for example, at three places on the outer circumference of a disk shaped fixed side disk portion 16a; and a fixed side coil electrode 17 in which a fixed side circular arc shaped coil portion 17c along an outer circumferential edge of the fixed side contact 15 is arranged being divided in plurality, for example, arranged being divided evenly into three places by a fixed side slit 17e (not shown in the drawing) on the rear surface side of the fixed side power feeding plate 16 and in which a fixed side circular arc shaped protrusion portion 17f of a circular arc shaped portion whose circumferential length is shorter than the circumferential length of a circular arc shaped portion of the fixed side circular arc shaped power feeding portion 16b is fixed at the position of the fixed side circular arc shaped coil portion 17c arranged evenly, for example, at three places, the position being faced to the fixed side circular arc shaped power feeding portion 16b. One end of the fixed side circular arc shaped coil portion 17c has a fixed side lateral arm portion 17b (not shown in the drawing) coupled to a fixed side coil electrode fitting portion 17a.

The movable side electrode 18 includes: the movable side contact 19 which is formed in a disk shape and is formed with a movable side contact back spot facing portion 19a on a back surface; a movable side power feeding plate 20 which is fixed to the inner surface of the movable side contact back spot facing portion 19a of the movable side contact 19 and has a movable side circular arc shaped power feeding portion 20b arranged evenly, for example, at three places on the outer circumference of a disk shaped movable side disk portion 20a; and a movable side coil electrode 21 in which a movable side circular arc shaped coil portion 21c along an outer circumferential edge of the movable side contact 19 is arranged being divided in plurality, for example, arranged evenly at three places by a movable side slit 21e on the rear surface side of the movable side power feeding plate 20 and in which a movable side circular arc shaped protrusion portion 21f of a circular arc shaped portion whose circumferential length is shorter than the circumferential length of a circular arc shaped portion of the movable side circular arc shaped power feeding portion 20b is fixed at the position of the movable side circular arc shaped coil portion 21c arranged evenly, for example, at three places, the position being faced to the movable side circular arc shaped power feeding portion 20b. One end of the movable side circular arc shaped coil portion 21c has a movable side lateral arm portion 21b coupled to a movable side coil electrode fitting portion 21a.

A fixed side disk portion 22a and a fixed side strut portion 22b are included, the fixed side disk portion 22a is brought into contact with the fixed side power feeding plate 16, and the fixed side strut portion 22b is fixed to a fixed side energization rod fitting portion 5a (not shown in the drawing) of the fixed side energization rod 5 to form a fixed side reinforcing member 22; and a movable side disk portion 23a and a movable side strut portion 23b are included, the movable side disk portion 23a is brought into contact with a movable side power feeding plate 20, and the movable side strut portion 23b is fixed to a movable side energization rod fitting portion 6a of the movable side energization rod 6 to form a movable side reinforcing member 23.

A fixed side cavity 24 is formed between the fixed side contact back spot facing portion 15a and the fixed side circular arc shaped power feeding portion 16b; a movable side cavity 25 is formed between the movable side contact back spot facing portion 19a and the movable side circular arc shaped power feeding portion 20b; a fixed side air gap 26 is formed between the fixed side circular arc shaped coil portion 17c and the fixed side circular arc shaped power feeding portion 16b; and a movable side air gap 27 is formed between the movable side circular arc shaped coil portion 21c and the movable side circular arc shaped power feeding portion 20b.

The fixed side power feeding plate 16 includes the disk shaped fixed side disk portion 16a and the fixed side circular arc shaped power feeding portion 16b formed in a circular arc shape from the fixed side disk portion 16a. A surface on the fixed side coil electrode 17 side of the fixed side circular arc shaped power feeding portion 16b has a connection part to be connected to the fixed side coil electrode 17 and an opposite part adjacent to the connection part; and the opposite part is faced to the fixed side circular arc shaped coil portion 17c of the fixed side coil electrode 17 via the air gap. As to the fixed side coil electrode 17, in addition to the fixed side fitting portion 17a to be fitted with the fixed side energization rod fitting portion 5a (not shown in the drawing) of the fixed side energization rod 5, a plurality of the circular arc shaped fixed side circular arc shaped coil portion 17c is arranged being divided by the fixed side slit 17e (not shown in the drawing) and one end of the fixed side circular arc shaped coil portion 17c has the fixed side circular arc shaped protrusion portion 17f that is vertically protruded. Incidentally, the fixed side power feeding plate 16 may be permissible to use the same material as the fixed side coil electrode 17, for example, copper or the like; however, it is not particularly limited and it may be permissible to use material different from the fixed side coil electrode 17.

The movable side power feeding plate 20 includes the disk shaped movable side disk portion 20a and the movable side circular arc shaped power feeding portion 20b formed in a circular arc shape from the movable side disk portion 20a, as shown in FIG. 3. A surface on the movable side circular arc shaped power feeding portion 20b side has a connection part to be connected to the movable side coil electrode 21 and an opposite part adjacent to the connection part; and the opposite part is faced to the movable side circular arc shaped coil portion 21c of the movable side coil electrode 21 via an air gap. As to the movable side coil electrode 21, as shown in FIG. 4, in addition to the movable side coil electrode fitting portion 21a to be fitted with the movable side energization rod fitting portion 6a of the movable side energization rod 6, a plurality of the circular arc shaped movable side circular arc shaped coil portion 21c is arranged being divided by the movable side slit 21e and one end of the movable side circular arc shaped coil portion 21c has the movable side circular arc shaped protrusion portion 21f that is vertically protruded. Incidentally, the movable side power feeding plate 20 may be permissible to use the same material as the movable side coil electrode 21, for example, copper or the like; however, it is not particularly limited and it may be permissible to use material different from the movable side coil electrode 21.

One end of the fixed side circular arc shaped power feeding portion 16b of the fixed side power feeding plate 16 is fixed in a state circumferentially conformed with respect to the fixed side circular arc shaped protrusion portion 17f and the circumferential length of the fixed side circular arc shaped protrusion portion 17f is shorter than the circumferential length of the fixed side circular arc shaped power feeding portion 16b; thus, the fixed side air gap 26 is provided between the fixed side circular arc shaped power feeding portion 16b that is not fixed to the fixed side circular arc shaped coil portion 17c and the fixed side circular arc shaped coil portion 17c.

One end of the movable side circular arc shaped power feeding portion 20b of the movable side power feeding plate 20 is fixed in a state circumferentially conformed with respect to the movable side circular arc shaped protrusion portion 21f and the circumferential length of the movable side circular arc shaped protrusion portion 21f is shorter than the circumferential length of the movable side circular arc shaped power feeding portion 20b; thus, the movable side air gap 27 is provided between the movable side circular arc shaped power feeding portion 20b that is not fixed to the movable side circular arc shaped coil portion 21c and the movable side circular arc shaped coil portion 21c, as shown in FIG. 6.

The fixed side contact 15 is provided with the fixed side contact back spot facing portion 15a on a back surface opposite to an opposite surface and a surface opposite to the surface of the fixed side circular arc shaped power feeding portion 16b fixed to the fixed side circular arc shaped protrusion portion 17f is fixed. Since something to be fixed is not present in the circumferential direction of the fixed side circular arc shaped power feeding portion 16b and the fixed side contact back spot facing portion 15a, the fixed side cavity 24 is formed.

As shown in FIGS. 5A, 5B, the movable side contact 19 is provided with the movable side contact back spot facing portion 19a on a back surface opposite to an opposite surface; and a surface opposite to the surface of the movable side circular arc shaped power feeding portion 20b fixed to the movable side circular arc shaped protrusion portion 21f is fixed. Since something to be fixed is not present in the circumferential direction of the movable side circular arc shaped power feeding portion 20b and the movable side contact back spot facing portion 19a, the movable side cavity 25 is formed as shown in FIG. 6.

The umbrella shaped fixed side reinforcing member 22 having the fixed side disk portion 22a and the fixed side strut portion 22b is provided between the fixed side coil electrode 17 and the fixed side power feeding plate 16 to reinforce the fixed side contact 15, the fixed side strut portion 22b is fixed to the fixed side energization rod 5, and the fixed side disk portion 22a is arranged being brought into contact with the fixed side disk portion 16a of the fixed side power feeding plate 16; thus, the fixed side contact 15 is reinforced.

The umbrella shaped movable side reinforcing member 23 having the movable side disk portion 23a and the movable side strut portion 23b is provided between the movable side coil electrode 21 and the movable side power feeding plate 20 to reinforce the movable side contact 19, the movable side strut portion 23b is fixed to the movable side energization rod 6, and the movable side disk portion 23a is arranged being brought into contact with the movable side disk portion 20a of the movable side power feeding plate 20; thus, the movable side contact 19 is reinforced.

In the case of the configuration of the above vacuum interrupter according to Embodiment 1, a current flowed from the fixed side energization rod 5 or the movable side energization rod 6 to the fixed side coil electrode 17 or the movable side coil electrode 21 passes through the fixed side power feeding plate 16 or the movable side power feeding plate 20 and flows from the fixed side circular arc shaped power feeding portion 16b or the movable side circular arc shaped power feeding portion 20b to the fixed side contact 15 or the movable side contact 19. It becomes possible to extend a current path of the fixed side circular arc shaped coil portion 17c of the fixed side coil electrode 17 or the movable side circular arc shaped coil portion 21c of the movable side coil electrode 21 by making the fixed side power feeding plate 16 or the movable side power feeding plate 20 have a power feeding function from the fixed side coil electrode 17 or the movable side coil electrode 21 to the fixed side contact 15 or the movable side contact 19.

Furthermore, the fixed side air gap 26 is provided between the fixed side circular arc shaped power feeding portion 16b having the power feeding function and the fixed side circular arc shaped coil portion 17c, or the movable side air gap 27 is provided between the movable side circular arc shaped power feeding portion 20b having the power feeding function and the movable side circular arc shaped coil portion 21c: thus, a current flows so as to pass the lower side of the fixed side circular arc shaped power feeding portion 16b or the movable side circular arc shaped power feeding portion 20b.

Furthermore, since the fixed side cavity 24 or the movable side cavity 25 is formed, the current is difficult to flow in the circumferential direction from the fixed side circular arc shaped power feeding portion 16b or the movable side circular arc shaped power feeding portion 20b and a current flows only in the vertical direction toward the fixed side contact 15 or the movable side contact 19.

Here, if the outer diameter of the fixed side circular arc shaped power feeding portion 16b or the movable side circular arc shaped power feeding portion 20b is set to A as shown in FIG. 4 and the diameter of the fixed side contact back spot facing portion 15a or the movable side contact back spot facing portion 19a is set to B as shown in FIG. 5, it is desirable to establish the relationship of A≤B from the standpoint of assembly. It goes without saying that it is no problem to apply round machining or taper machining to an edge of each part in terms of machining.

Furthermore, by the above Embodiment 1, in addition to elongation of the current path of the fixed side circular arc shaped coil portion 17c or the movable side circular arc shaped coil portion 21c, the current passes through the lower side of the fixed side circular arc shaped power feeding portion 16b or the movable side circular arc shaped power feeding portion 20b; thus, it becomes possible to generate an axial magnetic field also at a place having the power feeding function, an area in which magnetic flux density effective for diffusing electric arc in a contact surface, the area being referred to as an effective magnetic field area, is extended, current density to be burdened per unit area of the contact surface during current interruption is reduced, and interrupting performance is improved.

Furthermore, in the known vacuum interrupter that generates the axial magnetic field and improves interrupting performance, a problem also exists in that an eddy current is induced in the contact and a magnetic field generated due to the eddy current weakens the axial magnetic field generated by the coil electrode. It is known that a radial slit is provided in the contact to avoid the eddy current; however, the slit passing through the contact causes a new problem that becomes a defect part with respect to withstand voltage performance between opposite contacts in a vacuum interrupter used especially at a class of high rated voltage. Further, it is also known that a radial groove which does not pass through a contact is provided in the coil electrode side of the contact; however, the groove needs to be provided being carefully processed by a small edged tool and accordingly a problem exists in that it requires time for a contact manufacturing process and it becomes expensive.

However, as in the above Embodiment 1, the current is difficult to flow in the circumferential direction from the fixed side circular arc shaped power feeding portion 16b or the movable side circular arc shaped power feeding portion 20b by forming the fixed side cavity 24 or the movable side cavity 25 and the eddy current flowing in the fixed side contact 15 or the movable side contact 19 can be suppressed while avoiding deterioration in withstand voltage performance due to providing the slit in the fixed side contact 15 or the movable side contact 19. If the eddy current is suppressed, magnetic field strength and the effective magnetic field area are improved and interrupting performance is further improved. Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

The fixed side power feeding plate 16 or the movable side power feeding plate 20 in the above Embodiment 1 can be manufactured easily and relatively inexpensively by press working. Additionally, the area having effective magnetic flux density required by a smaller diameter than the known coil electrode can be secured and thus a reduction in diameter of the coil electrode is achieved. Furthermore, since the reduction in diameter is achieved, an increase in size of the contact as before can be suppressed even if an energization current value is increased.

Along with the reduction in diameter of the coil electrode, a reduction in diameter of other components of the vacuum interrupter can also be performed, and it can contribute to a reduction in diameter or a reduction in weight of the whole vacuum interrupter. As a matter of course, it is also linked to the reduction in cost by actualizing the reduction in diameter or a reduction in weight of the vacuum interrupter.

In the above Embodiment 1, an example of applying the power feeding plate to both the fixed side electrode and the movable side electrode has been shown; however, it may be permissible to provide the power feeding plate in either the fixed side electrode or the movable side electrode. Furthermore, it may also be permissible to provide the contact back spot facing portion of the contact rear surface in either the fixed side electrode or the movable side electrode.

### Embodiment 2

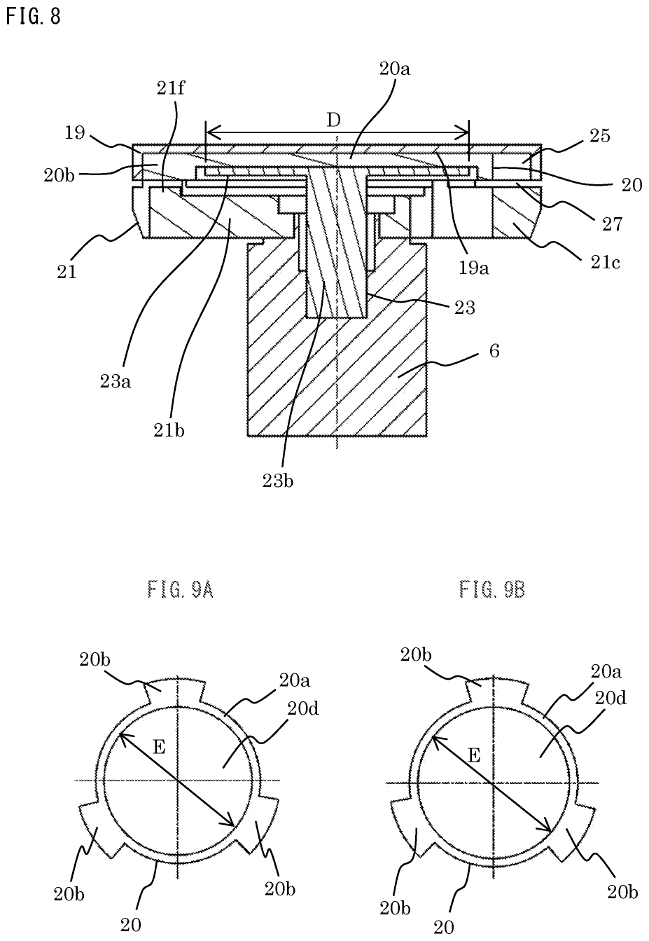

Embodiment 2 of the present application will be described based on FIGS. 7A, 7B and FIG. 8; and, in each of the drawings, identical or equivalent members and parts will be described with the same reference numerals (and letters) assigned thereto. FIGS. 7A, 7B are views showing a power feeding plate in a vacuum interrupter according to Embodiment 2, FIG. 7A is a front view, and FIG. 7B is a rear view. FIG. 8 is a sectional view showing an electrode structure in the vacuum interrupter according to Embodiment 2.

In contrast to the structure of the vacuum interrupter presented in the above Embodiment 1, Embodiment 2 of the present application is different only in the shape of a fixed side power feeding plate 16 or a movable side power feeding plate 20. Description will be made based on, for example, a movable side electrode 18 in Embodiment 2 of the present application. As shown in FIGS. 7A, 7B, as with the movable side power feeding plate 20 shown in the above Embodiment 1, there are included a disk shaped movable side disk portion 20a and a movable side circular arc shaped power feeding portion 20b formed in a circular arc shape from the movable side disk portion 20a. Then, a movable side power feeding plate spot facing portion 20c is formed on the back surface of the movable side disk portion 20a.

The rear surface of the movable side circular arc shaped power feeding portion 20b is fixed to each one end in a state circumferentially conformed with respect to a movable side circular arc shaped protrusion portion 21f of a movable side coil electrode 21, as with the above Embodiment 1. The circumferential length of the movable side circular arc shaped protrusion portion 21f is shorter than the circumferential length of the movable side circular arc shaped power feeding portion 20b; thus, as shown in FIG. 8, a movable side air gap 27 is provided between the movable side circular arc shaped power feeding portion 20b that is not fixed to a movable side circular arc shaped coil portion 21c and the movable side circular arc shaped coil portion 21c, the surface of the movable side circular arc shaped power feeding portion 20b which is opposite to the surface fixed to the movable side circular arc shaped protrusion portion 21f is fixed to a movable side contact back spot facing portion 19a, and a movable side cavity 25 is formed between the movable side circular arc shaped power feeding portion 20b and the movable side contact back spot facing portion 19a.

An umbrella shaped movable side reinforcing member 23 having a movable side disk portion 23a and a movable side strut portion 23b is provided between the movable side coil electrode 21 and the movable side power feeding plate 20 to reinforce a movable side contact 19, the movable side strut portion 23b is fixed to a movable side energization rod 6, and the movable side disk portion 23a is arranged being brought into contact with the movable side power feeding plate spot facing portion 20c of the movable side power feeding plate 20; thus, the movable side contact 19 is reinforced.

Also in this Embodiment 2, a current flowed from the movable side energization rod 6 to the movable side coil electrode 21 passes through the movable side power feeding plate 20 and flows from the movable side circular arc shaped power feeding portion 20b to the movable side contact 19. It becomes possible to extend a current path of the movable side circular arc shaped coil portion 21c of the movable side coil electrode 21 by making the movable side power feeding plate 20 have a power feeding function from the movable side coil electrode 21 to the movable side contact 19.

Furthermore, the movable side air gap 27 is provided between the movable side circular arc shaped power feeding portion 20b having the power feeding function and the movable side circular arc shaped coil portion 21c; thus, the current passes through the lower side of the movable side circular arc shaped power feeding portion 20b. Moreover, since the movable side cavity 25 is formed, the current is difficult to flow in a circumferential direction from the movable side circular arc shaped power feeding portion 20b and the current flows only in a vertical direction toward the movable side contact 19.

The movable side power feeding plate spot facing portion 20c is provided on the movable side power feeding plate 20; thus, a clearance is generated in axial dimension between the movable side power feeding plate 20 and the movable side coil electrode 21 and it becomes possible to elongate the entire length of the movable side reinforcing member 23 or to increase the thickness of the movable side disk portion 23a of the movable side reinforcing member 23.

Here, if the diameter of the movable side power feeding plate spot facing portion 20c is set to C as shown in FIG. 7 and the outer diameter of the movable side disk portion 23a of the movable side reinforcing member 23 is set to D as shown in FIG. 8, it is desirable that the relationship of D C is established from the standpoint of assembly. Furthermore, it goes without saying that it is no problem to apply round machining or taper machining to an edge of each part in terms of machining.

Also by this Embodiment 2, in addition to elongation of the current path of the movable side circular arc shaped coil portion 21c, the current passes through the lower side of the movable side circular arc shaped power feeding portion 20b; thus, it becomes possible to generate an axial magnetic field also at a place having the power feeding function, an effective magnetic field area is extended, current density to be burdened per unit area of a contact surface during current interruption is reduced, and interrupting performance is improved.

Further, as with the above Embodiment 1, the movable side cavity 25 is formed and the current is difficult to flow in the circumferential direction from the movable side circular arc shaped power feeding portion 20b; thus, an eddy current flowing in the movable side contact 19 can be suppressed while avoiding deterioration in withstand voltage performance due to providing a slit in the movable side contact 19. If the eddy current is suppressed, magnetic field strength and the effective magnetic field area are improved and the interrupting performance is improved.

Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

Furthermore, the movable side reinforcing member 23 is formed of stainless steel or the like, is made of material which is higher in strength and higher in electrical resistivity than the movable side coil electrode 21 or the movable side power feeding plate 20 and the movable side contact 19, and is no different from a conductor; thus, although a leakage current flows, the clearance is generated in axial dimension between the movable side power feeding plate 20 and the movable side coil electrode 21 by providing the movable side power feeding plate spot facing portion 20c on the movable side power feeding plate 20, it becomes possible to elongate the entire length of the movable side reinforcing member 23, specific resistance of the movable side reinforcing member 23 is increased, and the leakage current is difficult to flow in the movable side reinforcing member 23.

If the leakage current is difficult to flow, the current flowing in the movable side coil electrode 21 is increased and it becomes possible to improve magnetic field strength and the effective magnetic field area.

It may be permissible to elongate the entire length of the movable side reinforcing member 23 by increasing the thickness of the movable side disk portion 23a of the movable side reinforcing member 23. In this case, since the strength of the movable side reinforcing member 23 is increased, it becomes possible to expand an application range to specification in which the mass of a movable portion is heavy and high strength sustainable against contact closing impact during close-contact is required.

The movable side power feeding plate 20 in this Embodiment 2 can be manufactured easily and relatively inexpensively by press working. Cutting of the movable side power feeding plate spot facing portion 20c can also be performed by a relatively large edged tool and thus it is not linked to a considerable increase in cost. Additionally, if this Embodiment 2 is adopted, an area having effective magnetic flux density required by a smaller diameter than the known movable side coil electrode can be secured and thus a reduction in diameter of the movable side coil electrode is achieved.

Along with the reduction in diameter of the movable side coil electrode, a reduction in diameter of other components of the vacuum interrupter can also be performed and it can contribute to a reduction in diameter or a reduction in weight of the whole vacuum interrupter. As a matter of course, it is also linked to a reduction in cost by actualization of the reduction in diameter or the reduction in weight of the vacuum interrupter.

By the way, in the above Embodiment 2, although the description has been made based on the movable side electrode 18, the same configuration as the movable side electrode 18 can also be applied to the fixed side electrode 14 and the same effect can be exhibited. More specifically, as with the fixed side power feeding plate 16 shown in the above Embodiment 1, there are included a disk shaped fixed side disk portion 16a and a fixed side circular arc shaped power feeding portion 16b formed in a circular arc shape from the fixed side disk portion 16a; and it may be permissible that a fixed side power feeding plate spot facing portion 16c (not shown in the drawing) is formed on the back surface of the fixed side disk portion 16a and a fixed side disk portion 22a of a fixed side reinforcing member 22 is arranged being brought into contact with the fixed side power feeding plate spot facing portion 16c of the fixed side power feeding plate 16.

### Embodiment 3

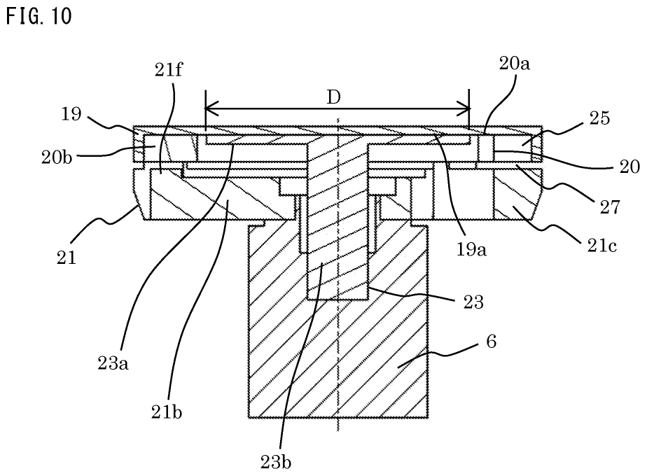

Embodiment 3 of the present application will be described based on FIGS. 9A, 9B and FIG. 10; and, in each of the drawings, identical or equivalent members and parts will be described with the same reference numerals (and letters) assigned thereto. FIGS. 9A, 9B are views showing a power feeding plate in a vacuum interrupter according to Embodiment 3, FIG. 9A is a front view, and FIG. 9B is a rear view. FIG. 10 is a sectional view showing an electrode structure in the vacuum interrupter according to Embodiment 3.

In contrast to the structure of the vacuum interrupter presented in the above Embodiment 1, Embodiment 3 of the present application is different only in the shape of a fixed side power feeding plate 16 or a movable side power feeding plate 20. Description will be made based on the movable side power feeding plate 20 in Embodiment 3 of the present application. As shown in FIGS. 9A, 9B, there are included a disk shaped movable side disk portion 20a and a movable side circular arc shaped power feeding portion 20b that is formed in a circular arc shape from the movable side disk portion 20a, as with the movable side power feeding plate 20 shown in the above Embodiment 1. Then, a movable side power feeding plate through hole 20d is formed in the movable side disk portion 20a.

The rear surface of the movable side circular arc shaped power feeding portion 20b is fixed to each one end in a state circumferentially conformed with respect to a movable side circular arc shaped protrusion portion 21f of a movable side coil electrode 21, as with the above Embodiment 1. The circumferential length of the movable side circular arc shaped protrusion portion 21f is shorter than the circumferential length of the movable side circular arc shaped power feeding portion 20b; thus, as shown in FIG. 10, a movable side air gap 27 is provided between the movable side circular arc shaped power feeding portion 20b that is not fixed to a movable side circular arc shaped coil portion 21c and the movable side circular arc shaped coil portion 21c, the surface of the movable side circular arc shaped power feeding portion 20b which is opposite to the surface fixed to the movable side circular arc shaped protrusion portion 21f is fixed to a movable side contact back spot facing portion 19a, and a movable side cavity 25 is formed between the movable side circular arc shaped power feeding portion 20b and the movable side contact back spot facing portion 19a.

An umbrella shaped movable side reinforcing member 23 having a movable side disk portion 23a and a movable side strut portion 23b is provided on the rear surface of a movable side contact 19 to reinforce the movable side contact 19, the movable side strut portion 23b is fixed to a movable side energization rod 6, the movable side disk portion 23a of the movable side reinforcing member 23 passes through the movable side power feeding plate through hole 20d of the movable side power feeding plate 20 and is arranged being brought into contact with the inner surface of the movable side contact back spot facing portion 19a of the movable side contact 19; thus, the movable side contact 19 is reinforced.

Also in this Embodiment 3, a current flowed from the movable side energization rod 6 to the movable side coil electrode 21 passes through the movable side power feeding plate 20 and flows from the movable side circular arc shaped power feeding portion 20b to the movable side contact 19. It becomes possible to extend a current path of the movable side circular arc shaped coil portion 21c of the movable side coil electrode 21 by making the movable side power feeding plate 20 have a power feeding function from the movable side coil electrode 21 to the movable side contact 19.

Furthermore, the movable side air gap 27 is provided between the movable side circular arc shaped power feeding portion 20b having the power feeding function and the movable side circular arc shaped coil portion 21c; thus, the current passes through the lower side of the movable side circular arc shaped power feeding portion 20b. Moreover, since the movable side cavity 25 is formed, the current is difficult to flow in a circumferential direction from the movable side circular arc shaped power feeding portion 20b and the current flows only in a vertical direction toward the movable side contact 19.

The movable side power feeding plate through hole 20d is provided in the movable side power feeding plate 20; thus, more than the above Embodiment 2, a clearance is generated in axial dimension between the movable side power feeding plate 20 and the movable side coil electrode 21 and it becomes possible to elongate the entire length of the movable side reinforcing member 23 or to increase the thickness of the movable side disk portion 23a of the movable side reinforcing member 23.

Here, if the diameter of the movable side power feeding plate through hole 20d is set to E as shown in FIGS. 9A, 9B and the outer diameter of the movable side disk portion 23a of the movable side reinforcing member 23 is set to D as shown in FIG. 10, it is desirable that the relationship of D E is established from the standpoint of assembly. Furthermore, it goes without saying that it is no problem to apply round machining or taper machining to an edge of each part in terms of machining.

Also in this Embodiment 3, in addition to elongation of the current path of the movable side circular arc shaped coil portion 21c, the current passes through the lower side of the movable side circular arc shaped power feeding portion 20b; thus, it becomes possible to generate an axial magnetic field also at a place having the power feeding function, an effective magnetic field area is extended, current density to be burdened per unit area of a contact surface during current interruption is reduced, and interrupting performance is improved.

Further, as with the above respective embodiments, the movable side cavity 25 is formed and the current is difficult to flow in the circumferential direction from the movable side circular arc shaped power feeding portion 20b; thus, an eddy current flowing in the movable side contact 19 can be suppressed while avoiding deterioration in withstand voltage performance due to providing a slit in the movable side contact 19. If the eddy current is suppressed, magnetic field strength and the effective magnetic field area are improved and the interrupting performance is improved.

Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

Furthermore, the movable side power feeding plate through hole 20d is provided in the movable side power feeding plate 20; thus, more than the above Embodiment 2, the clearance is generated in axial dimension between the movable side power feeding plate 20 and the movable side coil electrode 21 and it becomes possible to elongate the entire length of the movable side reinforcing member 23, specific resistance of the movable side reinforcing member 23 is increased, and the leakage current is difficult to flow in the movable side reinforcing member 23. If the leakage current is difficult to flow, the current flowing in the movable side coil electrode 21 is increased, and it becomes possible to improve the magnetic field strength and the effective magnetic field area.

In this Embodiment 3, as with the above Embodiment 2, it may be permissible to elongate the entire length of the movable side reinforcing member 23 by increasing the thickness of the movable side disk portion 23a of the movable side reinforcing member 23. In this case, since the strength of the movable side reinforcing member 23 is increased, it becomes possible to expand an application range to specification in which the mass of a movable portion is heavy and high strength sustainable against contact closing impact during close-contact is required.

The movable side power feeding plate 20 in this Embodiment 3 can be manufactured easily and relatively inexpensively by press working. Cutting of the movable side power feeding plate spot facing portion 20c can also be performed by a relatively large edged tool and thus it is not linked to a considerable increase in cost. Additionally, if this Embodiment 3 is adopted, an area having effective magnetic flux density required by a smaller diameter than the known movable side coil electrode can be secured and thus a reduction in diameter of the movable side coil electrode is achieved.

Along with the reduction in diameter of the movable side coil electrode, a reduction in diameter of other components of the vacuum interrupter can also be performed and it can contribute to a reduction in diameter or a reduction in weight of the whole vacuum interrupter. As a matter of course, it is also linked to a reduction in cost by actualization of the reduction in diameter or the reduction in weight of the vacuum interrupter.

By the way, in the above Embodiment 3, although the description has been made based on the movable side electrode 18, the same configuration as the movable side electrode 18 can also be applied to the fixed side electrode 14 and the same effect can be exhibited. More specifically, as with the fixed side power feeding plate 16 shown in the above Embodiment 1, there are included a disk shaped fixed side disk portion 16a and a fixed side circular arc shaped power feeding portion 16b formed in a circular arc shape from the fixed side disk portion 16a; and it may be permissible that a fixed side power feeding plate through hole 16d (not shown in the drawing) is formed in the fixed side disk portion 16a and a fixed side disk portion 22a of a fixed side reinforcing member 22 is made to pass through the fixed side power feeding plate through hole 16d of the fixed side power feeding plate 16 and is arranged being brought into contact with the inner surface of a fixed side contact back spot facing portion 15a of a fixed side contact 15.

### Embodiment 4

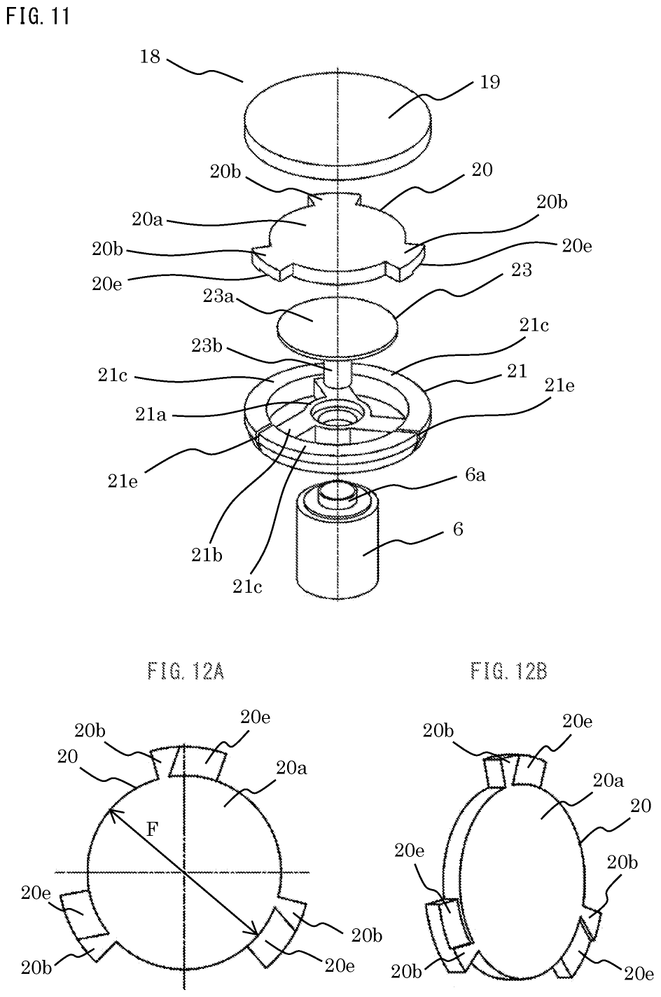

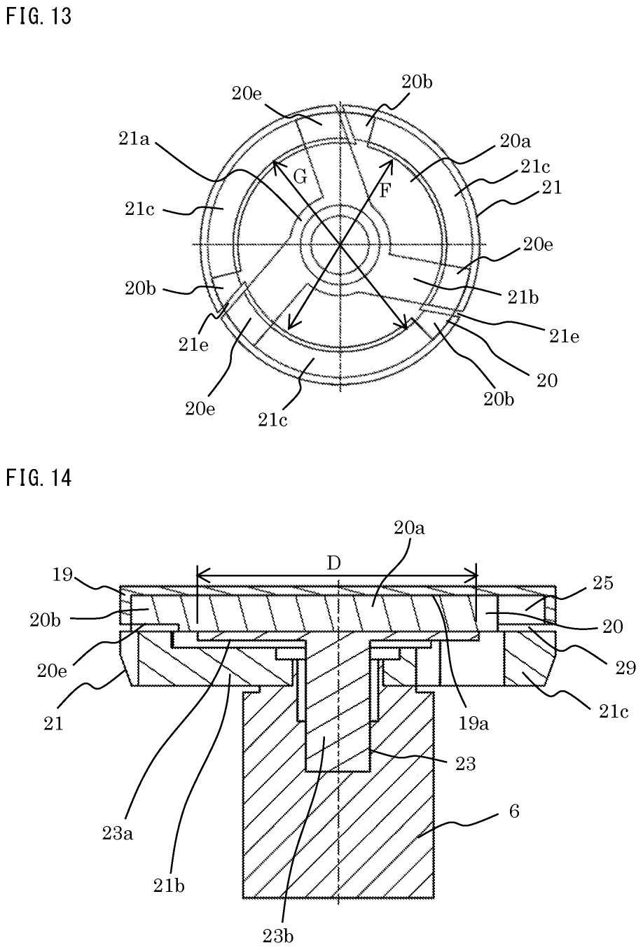

Embodiment 4 of the present application will be described based on FIG. 11 through FIG. 14; and, in each of the drawings, identical or equivalent members and parts will be described with the same reference numerals (and letters) assigned thereto. FIG. 11 is an exploded perspective view showing an electrode structure in a vacuum interrupter according to Embodiment 4. FIGS. 12A, 12B are views showing a power feeding plate in the vacuum interrupter according to Embodiment 4, FIG. 12A is a rear view, and FIG. 12B is a perspective view. FIG. 13 is a front view showing a state where a coil electrode and the power feeding plate are fixed in the vacuum interrupter according to Embodiment 4. FIG. 14 is a sectional view showing the electrode structure in the vacuum interrupter according to Embodiment 4.

In contrast to the structure of the vacuum interrupter presented in the above Embodiment 1, Embodiment 4 of the present application is different only in the shape of a fixed side coil electrode 17 or a movable side coil electrode 21 and a fixed side power feeding plate 16 or a movable side power feeding plate 20. Description will be made based on the movable side coil electrode 21 and the movable side power feeding plate 20 in Embodiment 4 of the present application. A movable side circular arc shaped protrusion portion 21f is not present in the movable side coil electrode 21 as shown in FIG. 11. As shown in FIG. 12A, 12B, the movable side power feeding plate 20 has a disk shaped movable side disk portion 20a and a movable side circular arc shaped power feeding portion 20b that is formed in a circular arc shape from the movable side disk portion 20a, as with the movable side power feeding plate 20 shown in the above Embodiment 1. Then, a movable side power feeding plate float portion 20e is provided on the rear surface of the movable side circular arc shaped power feeding portion 20b formed by cut or the like.

The rear surface of the movable side circular arc shaped power feeding portion 20b is fixed to the movable side circular arc shaped coil portion 21c so that inner one end of the movable side circular arc shaped power feeding portion 20b is made to conform circumferentially to the end surface of the movable side circular arc shaped coil portion 21c, as shown in FIG. 13. Furthermore, as shown in FIG. 14, a movable side float portion air gap 29 is provided between the movable side power feeding plate float portion 20e that is not fixed to the movable side circular arc shaped coil portion 21c and the movable side circular arc shaped coil portion 21c; a surface opposite to the surface of the movable side circular arc shaped power feeding portion 20b is fixed to a movable side contact back spot facing portion 19a; and a movable side cavity 25 is formed between the movable side circular arc shaped power feeding portion 20b and the movable side contact back spot facing portion 19a.

An umbrella shaped movable side reinforcing member 23 having a movable side disk portion 23a and a movable side strut portion 23b is provided between the movable side coil electrode 21 and the movable side power feeding plate 20 to reinforce a movable side contact 19, the movable side strut portion 23b is fixed to a movable side energization rod 6, and the movable side disk portion 23a of the movable side reinforcing member 23 is arranged being brought into contact with the rear surface of the movable side disk portion 20a of the movable side power feeding plate 20; thus, the movable side contact 19 is reinforced.

Also in this Embodiment 4, a current flowed from the movable side energization rod 6 to the movable side coil electrode 21 passes through the movable side power feeding plate 20 and flows from the movable side circular arc shaped power feeding portion 20b to the movable side contact 19. It becomes possible to extend a current path of the movable side circular arc shaped coil portion 21c of the movable side coil electrode 21 by making the movable side power feeding plate 20 have a power feeding function from the movable side coil electrode 21 to the movable side contact 19.

Furthermore, the movable side float portion air gap 29 is provided between the movable side power feeding plate float portion 20e that is formed on the movable side circular arc shaped power feeding portion 20b having the power feeding function and the movable side circular arc shaped coil portion 21c; thus, the current passes through the lower side of the movable side circular arc shaped power feeding portion 20b. Moreover, since the movable side cavity 25 is formed, the current is difficult to flow in a circumferential direction from the movable side circular arc shaped power feeding portion 20b and the current flows only in a vertical direction toward the movable side contact 19.

Here, if the outer diameter of the movable side disk portion 20a of the movable side power feeding plate 20 is set to F and the inner diameter of the movable side circular arc shaped coil portion 21c is set to G as shown in FIG. 13, it is desirable that the relationship of F<G is established because the movable side disk portion 20a of the movable side power feeding plate 20 must not come into contact with the movable side circular arc shaped coil portion 21c.

In this Embodiment 4, the description has been made on the case using the shape in which the movable side power feeding plate spot facing portion 20c or the movable side power feeding plate through hole 20d as in the above Embodiment 2 or Embodiment 3 is not provided on the movable side disk portion 20a of the movable side power feeding plate 20. However, as a matter of course, it goes without saying that it is no problem that the movable side power feeding plate spot facing portion 20c or the movable side power feeding plate through hole 20d is provided with respect to the movable side disk portion 20a of the movable side power feeding plate 20 having the movable side power feeding plate float portion 20e to elongate the entire length of the movable side reinforcing member 23 or to thicken the movable side disk portion 23a of the movable side reinforcing member 23. Furthermore, it goes without saying also in this respect that it is no problem to apply round machining or taper machining to an edge of each part in terms of machining.

Also in this Embodiment 4, in addition to elongation of the current path of the movable side circular arc shaped coil portion 21c, the current passes through the lower side of the movable side circular arc shaped power feeding portion 20b; thus, it becomes possible to generate an axial magnetic field also at a place having the power feeding function, an effective magnetic field area is extended, current density to be burdened per unit area of a contact surface during current interruption is reduced, and interrupting performance is improved.

Further, as with the above respective embodiments, the movable side cavity 25 is formed and the current is difficult to flow in the circumferential direction from the movable side circular arc shaped power feeding portion 20b; thus, an eddy current flowing in the movable side contact 19 can be suppressed while avoiding deterioration in withstand voltage performance due to providing a slit in the movable side contact 19. If the eddy current is suppressed, magnetic field strength and the effective magnetic field area are improved and the interrupting performance is improved.

Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

Furthermore, if the movable side power feeding plate spot facing portion 20c or the movable side power feeding plate through hole 20d is provided in the movable side power feeding plate 20, a clearance is generated in axial dimension between the movable side power feeding plate 20 and the movable side coil electrode 21, it becomes possible to elongate the entire length of the movable side reinforcing member 23, specific resistance of the movable side reinforcing member 23 is increased, and a leakage current is difficult to flow in the movable side reinforcing member 23. If the leakage current is difficult to flow, the current flowing in the movable side coil electrode 21 is increased, and it becomes possible to improve the magnetic field strength and the effective magnetic field area.

In this Embodiment 4, it may be permissible to elongate the entire length of the movable side reinforcing member 23 by increasing the thickness of the movable side disk portion 23a of the movable side reinforcing member 23. In this case, since the strength of the movable side reinforcing member 23 is increased, it becomes possible to expand an application range to specification in which the mass of a movable portion is heavy and high strength sustainable against contact closing impact during close-contact is required.

The movable side power feeding plate 20 in this Embodiment 4 can be manufactured easily and relatively inexpensively by press working or the like. Although the movable side power feeding plate float portion 20e needs to be formed by cut or the like after press working, as compared to the above Embodiments 1 to 3, the movable side circular arc shaped protrusion portion 21f is provided in the above Embodiment 1 to 3; thus, considering this point that cutting of the movable side circular arc shaped coil portion 21c needs to be performed in a wide range, there is a possibility to be more inexpensive than the above Embodiment 1 to 3 depending on the size of the movable side coil electrode.

Additionally, if this Embodiment 4 is adopted, an area having effective magnetic flux density required by a smaller diameter than the known movable side coil electrode can be secured and thus a reduction in diameter of the movable side coil electrode is achieved. Along with the reduction in diameter of the movable side coil electrode, a reduction in diameter of other components of the vacuum interrupter can also be performed and it can contribute to a reduction in diameter or a reduction in weight of the whole vacuum interrupter. As a matter of course, it is also linked to a reduction in cost by actualization of the reduction in diameter or the reduction in weight of the vacuum interrupter.

By the way, in the above Embodiment 4, although the description has been made based on the movable side electrode 18, the same configuration as the movable side electrode 18 can also be applied to the fixed side electrode 14 and the same effect can be exhibited. More specifically, as with the fixed side power feeding plate 16 shown in the above Embodiment 1, there are included a disk shaped fixed side disk portion 16a and a fixed side circular arc shaped power feeding portion 16b formed in a circular arc shape from the fixed side disk portion 16a; and it may be permissible that a fixed side power feeding plate float portion 16e (not shown in the drawing) and a fixed side float portion air gap 28 (not shown in the drawing) which are formed by cut or the like are formed on the rear surface of the fixed side circular arc shaped power feeding portion 16b and a fixed side disk portion 22a of a fixed side reinforcing member 22 is arranged being brought into contact with the fixed side disk portion 16a of the fixed side power feeding plate 16.

### Embodiment 5

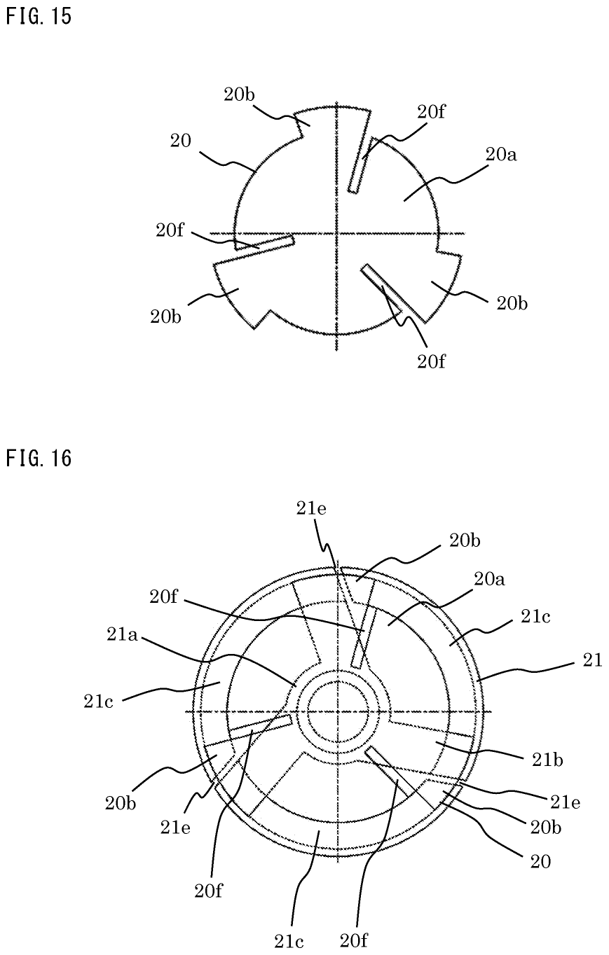

Embodiment 5 of the present application will be described based on FIG. 15 and FIG. 16; and, in each of the drawings, identical or equivalent members and parts will be described with the same reference numerals (and letters) assigned thereto. FIG. 15 is a front view showing a power feeding plate in a vacuum interrupter according to Embodiment 5. FIG. 16 is a front view showing a state where a coil electrode and the power feeding plate are fixed in the vacuum interrupter according to Embodiment 5.

In contrast to the structure of the vacuum interrupter presented in the above Embodiment 1, Embodiment 5 of the present application is different only in the shape of a fixed side power feeding plate 16 or a movable side power feeding plate 20. Description will be made based on the movable side power feeding plate 20 in Embodiment 5 of the present application. As shown in FIG. 15, the movable side power feeding plate 20 has a disk shaped movable side disk portion 20a and a movable side circular arc shaped power feeding portion 20b that is formed in a circular arc shape from the movable side disk portion 20a, as with the movable side power feeding plate 20 shown in the above Embodiment 1. Then, in Embodiment 5, a movable side power feeding plate slit 20f led so as to be along one end of the movable side circular arc shaped power feeding portion 20b is provided in the movable side disk portion 20a of the movable side power feeding plate 20.

A movable side coil electrode 21 and the movable side power feeding plate 20 are fixed as with the above Embodiment 1. As shown in FIG. 16, one end of a movable side circular arc shaped protrusion portion 21f of the movable side coil electrode 21 is arranged so as to conform to one end on the side along the movable side power feeding plate slit 20f of the movable side circular arc shaped power feeding portion 20b of the movable side power feeding plate 20. In contrast to the above Embodiment 1, since the only difference is that the movable side power feeding plate slit 20f is provided in the movable side power feeding plate 20, a movable side air gap 27 between the movable side circular arc shaped power feeding portion 20b and a movable side circular arc shaped coil portion 21c or a movable side cavity 25 between the movable side circular arc shaped power feeding portion 20b and a movable side contact back spot facing portion 19a is also formed in the same manner.

It is also the same that an umbrella shaped movable side reinforcing member 23 having a movable side disk portion 23a and a movable side strut portion 23b is provided between the movable side coil electrode 21 and the movable side power feeding plate 20 to reinforce a movable side contact 19, the movable side strut portion 23b is fixed to a movable side energization rod 6, and the movable side disk portion 23a is arranged being brought into contact with the movable side disk portion 20a of the movable side power feeding plate 20; thus, the movable side contact 19 is reinforced.

Also in this Embodiment 5, a current flowed from the movable side energization rod 6 to the movable side coil electrode 21 passes through the movable side power feeding plate 20 and flows from the movable side circular arc shaped power feeding portion 20b to the movable side contact 19. It becomes possible to extend a current path of the movable side circular arc shaped coil portion 21c of the movable side coil electrode 21 by making the movable side power feeding plate 20 have a power feeding function from the movable side coil electrode 21 to the movable side contact 19.

Furthermore, the movable side air gap 27 is provided between the movable side circular arc shaped power feeding portion 20b having the power feeding function and the movable side circular arc shaped coil portion 21c; thus, the current passes through the lower side of the movable side circular arc shaped power feeding portion 20b. Moreover, since the movable side cavity 25 is formed, the current is difficult to flow in a circumferential direction from the movable side circular arc shaped power feeding portion 20b and the current flows only in a vertical direction toward the movable side contact 19.

In this Embodiment 5, the description has been made on the case using the shape in which the movable side power feeding plate spot facing portion 20c or the movable side power feeding plate through hole 20d as in the above Embodiment 2 or Embodiment 3 is not provided on the movable side disk portion 20a of the movable side power feeding plate 20; however, as a matter of course, it goes without saying that it is no problem that the movable side power feeding plate spot facing portion 20c or the movable side power feeding plate through hole 20d is provided with respect to the movable side disk portion 20a of the movable side power feeding plate 20 having the movable side power feeding plate slit 20f to elongate the entire length of the movable side reinforcing member 23 or to thicken the movable side disk portion 23a of the movable side reinforcing member 23.

Furthermore, as in the above Embodiment 4, a movable side power feeding plate float portion 20e can also be provided on the rear surface of the movable side circular arc shaped power feeding portion 20b of the movable side power feeding plate 20 of this Embodiment 5. Furthermore, it goes without saying also in this respect that it is no problem to apply round machining or taper machining to an edge of each part in terms of machining.

Also in this Embodiment 5, in addition to elongation of the current path of the movable side circular arc shaped coil portion 21c, the current passes through the lower side of the movable side circular arc shaped power feeding portion 20b; thus, it becomes possible to generate an axial magnetic field also at a place having the power feeding function, an effective magnetic field area is extended, current density to be burdened per unit area of a contact surface during current interruption is reduced, and interrupting performance is improved.

Further, the movable side cavity 25 is formed as with the above respective embodiments. Then, in this Embodiment, the movable side power feeding plate slit 20f is provided and the current is difficult to flow across a wider range in the circumferential direction from the movable side circular arc shaped power feeding portion 20b; thus, an eddy current flowing in the movable side contact 19 can be suppressed while avoiding deterioration in withstand voltage performance due to providing a slit in the movable side contact 19.

If the eddy current is suppressed, magnetic field strength and the effective magnetic field area are improved and the interrupting performance is improved. Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

Furthermore, if the movable side power feeding plate spot facing portion 20c or the movable side power feeding plate through hole 20d is provided in the movable side power feeding plate 20, a clearance is generated in axial dimension between the movable side power feeding plate 20 and the movable side coil electrode 21, it becomes possible to elongate the entire length of the movable side reinforcing member 23, specific resistance of the movable side reinforcing member 23 is increased, and a leakage current is difficult to flow in the movable side reinforcing member 23. If the leakage current is difficult to flow, the current flowing in the movable side coil electrode 21 is increased, and it becomes possible to improve the magnetic field strength and the effective magnetic field area.

In this Embodiment 5, it may be permissible to elongate the entire length of the movable side reinforcing member 23 by increasing the thickness of the movable side disk portion 23a of the movable side reinforcing member 23. In this case, since the strength of the movable side reinforcing member 23 is increased, it becomes possible to expand an application range to specification in which the mass of a movable portion is heavy and high strength sustainable against contact closing impact during close-contact is required.

The movable side power feeding plate 20 in this Embodiment 5 is to merely form the movable side power feeding plate slit 20f by means of a saw or the like after the movable side disk portion 20a and the movable side circular arc shaped power feeding portion 20b are formed by press working; thus, it can be manufactured relatively inexpensively.

Additionally, if this Embodiment 5 is adopted, an area having effective magnetic flux density required by a smaller diameter than the known movable side coil electrode can be secured and thus a reduction in diameter of the movable side coil electrode is achieved. Along with the reduction in diameter of the movable side coil electrode, a reduction in diameter of other components of the vacuum interrupter can also be performed and it can contribute to a reduction in diameter or a reduction in weight of the whole vacuum interrupter. As a matter of course, it is also linked to a reduction in cost by actualization of the reduction in diameter or the reduction in weight of the vacuum interrupter.

By the way, in the above Embodiment 5, although the description has been made based on a movable side electrode 18, the same configuration as the movable side electrode 18 can also be applied to a fixed side electrode 14 and the same effect can be exhibited. More specifically, as with the fixed side power feeding plate 16 shown in the above Embodiment 1, there are included a disk shaped fixed side disk portion 16a and a fixed side circular arc shaped power feeding portion 16b formed in a circular arc shape from the fixed side disk portion 16a; and it may be permissible that a fixed side power feeding plate slit 16f (not shown in the drawing) led so as to be along one end of the fixed side circular arc shaped power feeding portion 16b is formed in the fixed side disk portion 16a and a fixed side disk portion 22a of a fixed side reinforcing member 22 is arranged being brought into contact with the fixed side disk portion 16a of the fixed side power feeding plate 16.

### Embodiment 6

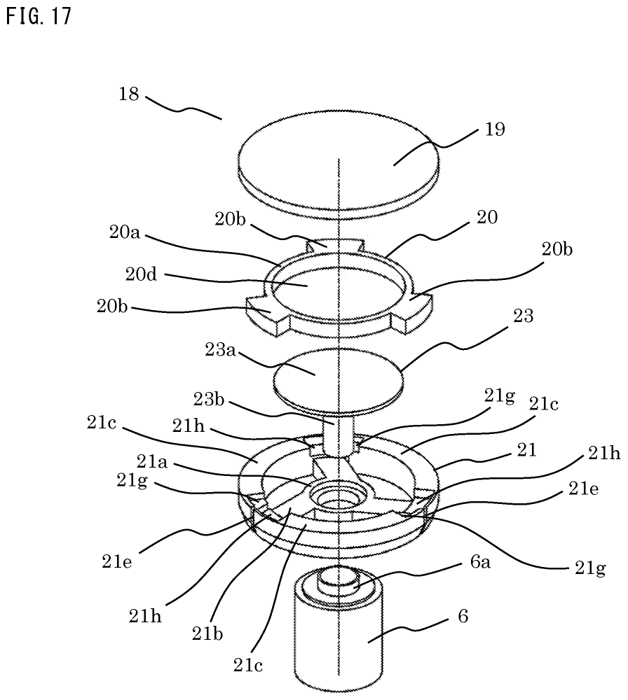

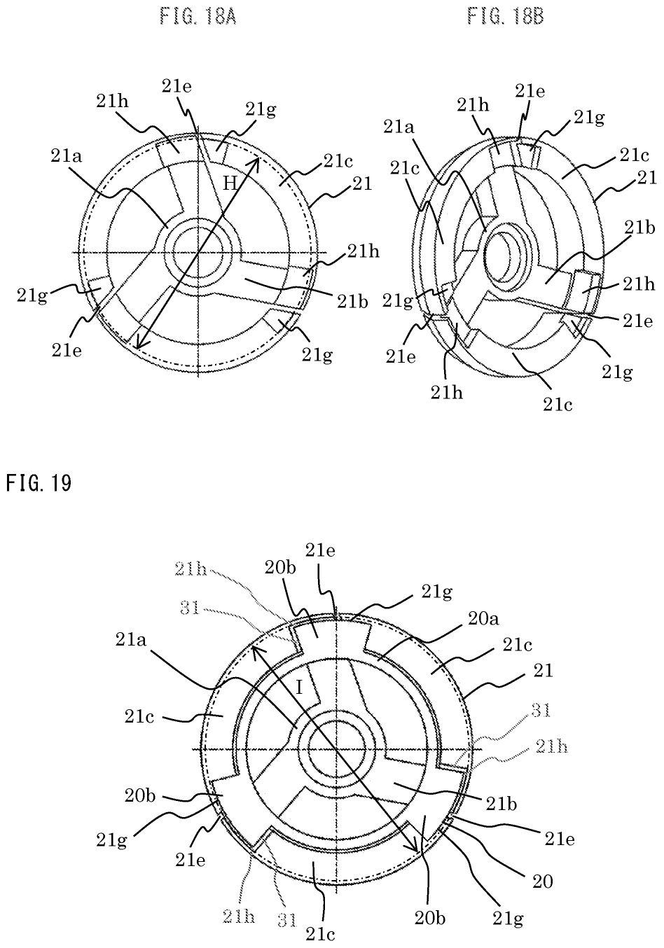

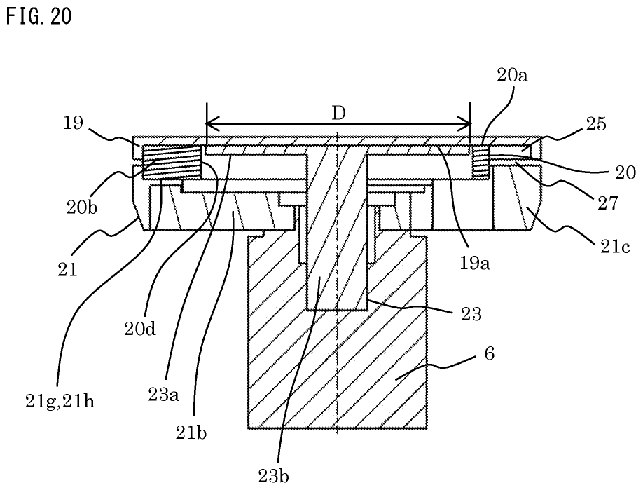

Embodiment 6 of the present application will be described based on FIG. 17 through FIG. 20; and, in each of the drawings, identical or equivalent members and parts will be described with the same reference numerals (and letters) assigned thereto. FIG. 17 is an exploded perspective view showing an electrode structure in a vacuum interrupter according to Embodiment 6. FIGS. 18A, 18B are views showing a coil electrode in the vacuum interrupter according to Embodiment 6, FIG. 18A is a front view, and FIG. 18B is a perspective view. FIG. 19 is a front view showing a state where the coil electrode and a power feeding plate are fixed in the vacuum interrupter according to Embodiment 6. FIG. 20 is a sectional view showing the electrode structure in the vacuum interrupter according to Embodiment 6.

In contrast to the structure of the vacuum interrupter presented in the above Embodiment 1 to 3, Embodiment 6 of the present application is different only in the shape of a fixed side coil electrode 17 or a movable side coil electrode 21. Description will be made based on the movable side coil electrode 21 in Embodiment 6 of the present application. For the sake of simplicity, as shown in FIG. 17, this Embodiment 6 will be described on the case where a movable side power feeding plate through hole 20d is provided in a movable side disk portion 20a of a movable side power feeding plate 20 as in the above Embodiment 3.

In the movable side coil electrode 21 in this Embodiment 6, as shown in FIG. 17 or FIGS. 18A, 18B, a movable side circular arc shaped first groove portion 21g is formed on a termination end portion of a movable side circular arc shaped coil portion 21c of the movable side coil electrode 21; a movable side circular arc shaped second groove portion 21h that is deeper than the depth of the movable side circular arc shaped first groove portion 21g is formed on a beginning end portion of the movable side circular arc shaped coil portion 21c of the movable side coil electrode 21 which sandwiches a movable side slit 21e, that is, at a position where a movable side lateral arm portion 21b of the movable side coil electrode 21 intersects with the movable side circular arc shaped coil portion 21c; a movable side circular arc shaped power feeding portion 20b of the movable side power feeding plate 20 is arranged over the movable side circular arc shaped first groove portion 21g and the movable side circular arc shaped second groove portion 21h; the movable side circular arc shaped power feeding portion 20b of the movable side power feeding plate 20 is fixed to the movable side circular arc shaped first groove portion 21g; and a movable side groove portion air gap 31 is formed between the movable side circular arc shaped power feeding portion 20b of the movable side power feeding plate 20 and the movable side circular arc shaped second groove portion 21h.

Here, if the outer diameter of the movable side circular arc shaped power feeding portion 20b is set to A, the outer diameter of the movable side circular arc shaped first groove portion 21g is set to H as shown in FIGS. 18A, 18B, and the outer diameter of the movable side circular arc shaped second groove portion 21h is set to I as shown in FIG. 19, it is desirable to set dimensions so as to establish the relationship of A≤H<I. The movable side circular arc shaped power feeding portion 20b undertakes power feeding between the movable side coil electrode 21 and a movable side contact 19; thus, the above dimensional relationship is set and the rear surface of the movable side circular arc shaped power feeding portion 20b is fixed to the movable side circular arc shaped first groove portion 21g as shown in FIG. 19.

Meanwhile, the depth of the movable side circular arc shaped second groove portion 21h is deeper than the depth of the movable side circular arc shaped first groove portion 21g, it is in the above dimensional relationship, and, as in FIG. 19, the groove width of the movable side circular arc shaped second groove portion 21h is set wide so as not to come into contact with the end surface on the side that does not come into contact with the movable side circular arc shaped first groove portion 21g of the movable side circular arc shaped power feeding portion 20b; thus, the movable side circular arc shaped second groove portion 21h does not come into contact with the movable side circular arc shaped power feeding portion 20b. Therefore, as shown in FIG. 19, a movable side groove portion air gap 31 is formed between the movable side circular arc shaped power feeding portion 20b and the movable side circular arc shaped second groove portion 21h.

The movable side circular arc shaped power feeding portion 20b of a surface that does not come into contact with the movable side circular arc shaped first groove portion 21g is fixed to a movable side contact back spot facing portion 19a; however, something to be fixed is not present in the circumferential direction of the movable side circular arc shaped power feeding portion 20b and thus a movable side cavity 25 is formed as shown in FIG. 20. An umbrella shaped movable side reinforcing member 23 having a movable side disk portion 23a and a movable side strut portion 23b is provided between the movable side coil electrode 21 and the movable side power feeding plate 20 to reinforce a movable side contact 19, the movable side strut portion 23b is fixed to a movable side energization rod 6, and the movable side disk portion 23a of the movable side reinforcing member 23 passes through the movable side power feeding plate through hole 20d of the movable side power feeding plate 20 and is arranged being brought into contact with the inner surface of the movable side contact back spot facing portion 19a of the movable side contact 19; thus, the movable side contact 19 is reinforced.

Also in this Embodiment 6, a current flowed from the movable side energization rod 6 to the movable side coil electrode 21 passes through the movable side power feeding plate 20 and flows from the movable side circular arc shaped power feeding portion 20b to the movable side contact 19. It becomes possible to extend a current path of the movable side circular arc shaped coil portion 21c of the movable side coil electrode 21 by making the movable side power feeding plate 20 have a power feeding function from the movable side coil electrode 21 to the movable side contact 19.

Furthermore, the movable side groove portion air gap 31 is provided between the movable side circular arc shaped power feeding portion 20b having the power feeding function and the movable side circular arc shaped second groove portion 21h; thus, the current passes through the lower side of the movable side circular arc shaped power feeding portion 20b. Moreover, since the movable side cavity 25 is formed, the current is difficult to flow in the circumferential direction from the movable side circular arc shaped power feeding portion 20b and the current flows only in a vertical direction toward the movable side contact 19.

In this Embodiment 6, the description has been made on the configuration of the case where the movable side power feeding plate through hole 20d is provided in the movable side disk portion 20a of the movable side power feeding plate 20; however, it may be permissible to use the movable side power feeding plate 20 in which any additional machining is not applied to the movable side disk portion 20a as in the above Embodiment 1, or it may be permissible to use the movable side power feeding plate 20 in which the movable side power feeding plate spot facing portion 20c is provided as in the above Embodiment 2. As a matter of course, it goes without saying that it may be permissible to use the movable side power feeding plate 20 having a movable side power feeding plate slit 20f shown in the above Embodiment 5. It goes without saying also in this respect that it is no problem to apply round machining or taper machining to an edge of each part in terms of machining.

Also in this Embodiment 6, in addition to elongation of the current path of the movable side circular arc shaped coil portion 21c, the current passes through the lower side of the movable side circular arc shaped power feeding portion 20b; thus, it becomes possible to generate an axial magnetic field also at a place having the power feeding function, an effective magnetic field area is extended, current density to be burdened per unit area of a contact surface during current interruption is reduced, and interrupting performance is improved.

Further, as with the above respective embodiments, the movable side cavity 25 is formed and the current is difficult to flow in the circumferential direction from the movable side circular arc shaped power feeding portion 20b; thus, an eddy current flowing in the movable side contact 19 can be suppressed more efficiently while avoiding deterioration in withstand voltage performance due to providing a slit in the movable side contact 19.

If the eddy current is suppressed, magnetic field strength and the effective magnetic field area are improved and the interrupting performance is improved. In this Embodiment 6, the height of the movable side power feeding plate 20 that protrudes from the movable side circular arc shaped coil portion 21c is low and therefore it becomes applicable to a thin movable side contact 19. In this case, the distance between the movable side circular arc shaped coil portion 21c and the surface of the movable side contact 19 is shortened, therefore, the strength of the axial magnetic field generated in the surface of the movable side contact 19 is enhanced and the interrupting performance is further improved.

Since the interrupting performance is improved, it also becomes possible to interrupt a larger current and it can contribute to an increase in current of the vacuum interrupter. Since the effective magnetic field area is extended, diffusion of electric arc of the contact surface is expedited and thermal damage of the contact surface is further reduced; thus, interrupting life is also improved and it also becomes possible to expand an application range to a large number of times of interrupting specification or the like.

The movable side coil electrode 21 in this Embodiment 6 needs to form the movable side circular arc shaped first groove portion 21g and the movable side circular arc shaped second groove portion 21h by cutting; however, considering that the whole movable side circular arc shaped coil portion 21c is processed so as to remain the movable side circular arc shaped protrusion portion 21f by the movable side coil electrode 21 as in the above Embodiment 1 to 3 and Embodiment 5, there is a possibility to become inexpensive by forming the movable side circular arc shaped first groove portion 21g and the movable side circular arc shaped second groove portion 21h by cutting.

Additionally, if this Embodiment 6 is adopted, an area having effective magnetic flux density required by a smaller diameter than the known movable side coil electrode can be secured and thus a reduction in diameter of the movable side coil electrode is achieved. Along with the reduction in diameter of the movable side coil electrode, a reduction in diameter of other components of the vacuum interrupter can also be performed and it can contribute to a reduction in diameter or a reduction in weight of the whole vacuum interrupter. As a matter of course, it is also linked to a reduction in cost by actualization of the reduction in diameter or the reduction in weight of the vacuum interrupter.

By the way, in the above Embodiment 6, although the description has been made based on the movable side electrode 18, the same configuration as the movable side electrode 18 can also be applied to a fixed side electrode 14 and the same effect can be exhibited. More specifically, as with the fixed side power feeding plate 16 shown in the above Embodiment 1, there are included a disk shaped fixed side disk portion 16a and a fixed side circular arc shaped power feeding portion 16b formed in a circular arc shape from the fixed side disk portion 16a; and it may be permissible that a fixed side circular arc shaped first groove portion 17g (not shown in the drawing) is formed on a termination end portion of a fixed side circular arc shaped coil portion 17c of a fixed side coil electrode 17, a fixed side circular arc shaped second groove portion 17h (not shown in the drawing) that is deeper than the depth of a fixed side circular arc shaped first groove portion 17g is formed on a beginning end portion of the fixed side circular arc shaped coil portion 17c of the fixed side coil electrode 17 which sandwiches a fixed side slit 17e (not shown in the drawing), that is, at a position where a fixed side lateral arm portion 17b of the fixed side coil electrode 17 intersects with the fixed side circular arc shaped coil portion 17c, the fixed side circular arc shaped power feeding portion 16b of the fixed side power feeding plate 16 is arranged over the fixed side circular arc shaped first groove portion 17g and the fixed side circular arc shaped second groove portion 17h, a fixed side groove portion air gap 30 (not shown in the drawing) is formed between the fixed side circular arc shaped power feeding portion 16b of the fixed side power feeding plate 16 and the fixed side circular arc shaped second groove portion 17h, and a fixed side disk portion 22a of a fixed side reinforcing member 22 is made to pass through a fixed side power feeding plate through hole 16d of the fixed side power feeding plate 16 and is arranged being brought into contact with the inner surface of a fixed side contact back spot facing portion 15a of a fixed side contact 15.

The present application describes various exemplified embodiments and examples; however, various features, aspects, and functions described in one or a plurality of embodiments are not limited to specific embodiments, but are applicable to embodiments individually or in various combinations thereof. Therefore, countless modified examples not exemplified are assumed in technical ranges disclosed in the specification of the present application. For example, there include: a case in which at least one constitutional element is modified; a case, added; or a case, omitted; and a case in which at least one constitutional element is extracted to combine with constitutional elements of other embodiments.

### INDUSTRIAL APPLICABILITY

The present application is suitable for actualizing a vacuum interrupter which can secure an effective magnetic field area and can improve current interrupting performance.

### DESCRIPTION OF REFERENCE NUMERALS

1 Insulation cylinder, 2 Fixed side flange, 3 Movable side flange, 5 Fixed side energization rod, 6 Movable side energization rod, 14 Fixed side electrode, 15 Fixed side contact, 15a Fixed side contact back spot facing portion, 16 Fixed side power feeding plate, 16a Fixed side disk portion, 16b Fixed side circular arc shaped power feeding portion, 16c Fixed side power feeding plate spot facing portion, 16d Fixed side power feeding plate through hole, 16e Fixed side power feeding plate float portion, 16f Fixed side power feeding plate slit, 17 Fixed side coil electrode, 17a Fixed side coil electrode fitting portion, 17b Fixed side lateral arm portion, 17c Fixed side circular arc shaped coil portion, 17e Fixed side slit, 17f Fixed side circular arc shaped protrusion portion, 17g Fixed side circular arc shaped first groove portion, 17h Fixed side circular arc shaped second groove portion, 18 Movable side electrode, 19 Movable side contact, 19a Movable side contact back spot facing portion, 20 Movable side power feeding plate, 20a Movable side disk portion, 20b Movable side circular arc shaped power feeding portion, 20c Movable side power feeding plate spot facing portion, 20d Movable side power feeding plate through hole, 20e Movable side power feeding plate float portion, 20f Movable side power feeding plate slit, 21 Movable side coil electrode, 21a Movable side coil electrode fitting portion, 21b Movable side lateral arm portion, 21c Movable side circular arc shaped coil portion, 21e Movable side slit, 21f Movable side circular arc shaped protrusion portion, 21g Movable side circular arc shaped first groove portion, 21h Movable side circular arc shaped second groove portion, 22 Fixed side reinforcing member, 22a Fixed side disk portion, 22b Fixed side strut portion, 23 Movable side reinforcing member, 23a Movable side disk portion, 23b Movable side strut portion, 24 Fixed side cavity, 25 Movable side cavity, 26 Fixed side air gap, 27 Movable side air gap, 28 Fixed side float portion air gap, 29 Movable side float portion air gap, 30 Fixed side groove portion air gap, 31 Movable side groove portion air gap

1. A vacuum interrupter comprising:
a cylindrical insulation container, a fixed side electrode arranged in the inside of the insulation container, and a movable side electrode which is arranged in the inside of the insulation container and is brought into contact with and separated from the fixed side electrode,
wherein the fixed side electrode and the movable side electrode each have a contact;
at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and
wherein the fixed side electrode includes: a fixed side contact which is formed in a disk shape and is formed with a fixed side contact back spot facing portion on a back surface, a fixed side power feeding plate which is fixed to the inner surface of the fixed side contact back spot facing portion of the fixed side contact and has a fixed side circular arc shaped power feeding portion on the outer circumference of a disk shaped fixed side disk portion, and a fixed side coil electrode in which a fixed side circular arc shaped coil portion along an outer circumferential edge of the fixed side contact is arranged being divided in plurality by a fixed side slit on the rear surface side of the fixed side power feeding plate and in which a fixed side circular arc shaped protrusion portion of a circular arc shaped portion whose circumferential length is shorter than the circumferential length of a circular arc shaped portion of the fixed side circular arc shaped power feeding portion is fixed at the position of the fixed side circular arc shaped coil portion, the position being faced to the fixed side circular arc shaped power feeding portion;
the movable side electrode includes: a movable side contact which is formed in a disk shape and is formed with a movable side contact back spot facing portion on a back surface, a movable side power feeding plate which is fixed to the inner surface of the movable side contact back spot facing portion of the movable side contact and has a movable side circular arc shaped power feeding portion on the outer circumference of a disk shaped movable side disk portion, and a movable side coil electrode in which a movable side circular arc shaped coil portion along an outer circumferential edge of the movable side contact is arranged being divided in plurality by a movable side slit on the rear surface side of the movable side power feeding plate and in which a movable side circular arc shaped protrusion portion of a circular arc shaped portion whose circumferential length is shorter than the circumferential length of a circular arc shaped portion of the movable side circular arc shaped power feeding portion is fixed at the position of the movable side circular arc shaped coil portion, the position being faced to the movable side circular arc shaped power feeding portion;
a fixed side reinforcing member, which has a fixed side disk portion and a fixed side strut portion, in which the fixed side disk portion is brought into contact with the fixed side power feeding plate, and in which the fixed side strut portion is fixed to a fixed side energization rod, is included;
a movable side reinforcing member, which has a movable side disk portion and a movable side strut portion, in which the movable side disk portion is brought into contact with the movable side power feeding plate, and in which the movable side strut portion is fixed to a movable side energization rod, is included; and
a fixed side cavity is formed between the fixed side contact back spot facing portion and the fixed side circular arc shaped power feeding portion, a movable side cavity is formed between the movable side contact back spot facing portion and the movable side circular arc shaped power feeding portion, a fixed side air gap is formed between the fixed side circular arc shaped coil portion and the fixed side circular arc shaped power feeding portion, and a movable side air gap is formed between the movable side circular arc shaped coil portion and the movable side circular arc shaped power feeding portion.

2. (canceled)

3. The vacuum interrupter according to claim 1,
wherein when the outer diameter of the fixed side circular arc shaped power feeding portion of the fixed side power feeding plate is set to A, the inner diameter of the fixed side contact back spot facing portion is set to B, the outer diameter of the movable side circular arc shaped power feeding portion of the movable side power feeding plate is set to A, and the inner diameter of the movable side contact back spot facing portion is set to B, the relationship of A≤B is established.

4. A vacuum interrupter comprising:
a cylindrical insulation container, a fixed side electrode arranged in the inside of the insulation container, and a movable side electrode which is arranged in the inside of the insulation container and is brought into contact with and separated from the fixed side electrode,
wherein the fixed side electrode and the movable side electrode each have a contact;
at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and
wherein the fixed side electrode includes: a fixed side contact which is formed in a disk shape and is formed with a fixed side contact back spot facing portion on a back surface, a fixed side power feeding plate which is fixed to the inner surface of the fixed side contact back spot facing portion of the fixed side contact and has a fixed side circular arc shaped power feeding portion on the outer circumference of a disk shaped fixed side disk portion, and a fixed side coil electrode in which a fixed side circular arc shaped coil portion along an outer circumferential edge of the fixed side contact is arranged being divided in plurality by a fixed side slit on the rear surface side of the fixed side power feeding plate;
the movable side electrode includes: a movable side contact which is formed in a disk shape and is formed with a movable side contact back spot facing portion on a back surface, a movable side power feeding plate which is fixed to the inner surface of the movable side contact back spot facing portion of the movable side contact and has a movable side circular arc shaped power feeding portion on the outer circumference of a disk shaped movable side disk portion, and a movable side coil electrode in which a movable side circular arc shaped coil portion along an outer circumferential edge of the movable side contact is arranged being divided in plurality by a movable side slit on the rear surface side of the movable side power feeding plate;
a fixed side reinforcing member, which has a fixed side disk portion and a fixed side strut portion, in which the fixed side disk portion is brought into contact with the fixed side power feeding plate, and in which the fixed side strut portion is fixed to a fixed side energization rod, is included;
a movable side reinforcing member, which has a movable side disk portion and a movable side strut portion, in which the movable side disk portion is brought into contact with the movable side power feeding plate, and in which the movable side strut portion is fixed to a movable side energization rod, is included;
a fixed side cavity is formed between the fixed side contact back spot facing portion and the fixed side circular arc shaped power feeding portion, and a movable side cavity is formed between the movable side contact back spot facing portion and the movable side circular arc shaped power feeding portion;
a fixed side power feeding plate float portion is formed on the rear surface of the fixed side circular arc shaped power feeding portion of the fixed side power feeding plate, a fixed side float portion air gap is formed between the fixed side power feeding plate float portion and the fixed side circular arc shaped coil portion, a movable side power feeding plate float portion is formed on the rear surface of the movable side circular arc shaped power feeding portion of the movable side power feeding plate, and a movable side float portion air gap is formed between the movable side power feeding plate float portion and the movable side circular arc shaped coil portion.

5. (canceled)

6. The vacuum interrupter according to claim 4,
wherein when the diameter of the fixed side disk portion of the fixed side power feeding plate is set to F, the inner diameter of the fixed side circular arc shaped coil portion of the fixed side coil electrode is set to G, the diameter of the movable side disk portion of the movable side power feeding plate is set to F, and the inner diameter of the movable side circular arc shaped coil portion of the movable side coil electrode is set to G, the relationship of F<G is established.

7. A vacuum interrupter comprising:
a cylindrical insulation container, a fixed side electrode arranged in the inside of the insulation container, and a movable side electrode which is arranged in the inside of the insulation container and is brought into contact with and separated from the fixed side electrode;
wherein the fixed side electrode and the movable side electrode each have a contact;
at least either the fixed side electrode or the movable side electrode includes: a power feeding plate having a circular arc shaped power feeding portion formed on the outer circumference of a disk portion, and a coil electrode in which a circular arc shaped coil portion along an outer circumferential edge of the contact is arranged being divided in plurality by a slit on the rear surface side of the power feeding plate and in which a circular arc protrusion portion whose circumferential length is shorter than the circumferential length of a circular arc shaped portion of the circular arc shaped power feeding portion is fixed at the position of the circular arc shaped coil portion, the position being faced to the circular arc shaped power feeding portion; and
a cavity is formed between the contact and the circular arc shaped power feeding portion, a circular arc shaped first groove portion is formed on a termination end portion of the circular arc shaped coil portion of the coil electrode, a circular arc shaped second groove portion that is deeper than the depth of the circular arc shaped first groove portion is formed on a beginning end portion of the circular arc shaped coil portion of the coil electrode which sandwiches the slit, the circular arc shaped power feeding portion of the power feeding plate is arranged over the circular arc shaped first groove portion and the circular arc shaped second groove portion, the circular arc shaped power feeding portion of the power feeding plate is fixed to the circular arc shaped first groove portion, and a groove portion air gap is formed between the circular arc shaped power feeding portion of the power feeding plate and the circular arc shaped second groove portion.

8. The vacuum interrupter according to claim 7,
wherein the fixed side electrode includes: a fixed side contact which is formed in a disk shape and is formed with a fixed side contact back spot facing portion on a back surface, a fixed side power feeding plate which is fixed to the inner surface of the fixed side contact back spot facing portion of the fixed side contact and has a fixed side circular arc shaped power feeding portion on the outer circumference of a disk shaped fixed side disk portion, and a fixed side coil electrode in which a fixed side circular arc shaped coil portion along an outer circumferential edge of the fixed side contact is arranged being divided in plurality by a fixed side slit on the rear surface side of the fixed side power feeding plate;
the movable side electrode includes: a movable side contact which is formed in a disk shape and is formed with a movable side contact back spot facing portion on a back surface, a movable side power feeding plate which is fixed to the inner surface of the movable side contact back spot facing portion of the movable side contact and has a movable side circular arc shaped power feeding portion on the outer circumference of a disk shaped movable side disk portion, and a movable side coil electrode in which a movable side circular arc shaped coil portion along an outer circumferential edge of the movable side contact is arranged being divided in plurality by a movable side slit on the rear surface side of the movable side power feeding plate;
a fixed side reinforcing member, which has a fixed side disk portion and a fixed side strut portion, in which the fixed side disk portion is brought into contact with the fixed side power feeding plate, and in which the fixed side strut portion is fixed to a fixed side energization rod, is included;
a movable side reinforcing member, which has a movable side disk portion and a movable side strut portion, in which the movable side disk portion is brought into contact with the movable side power feeding plate, and in which the movable side strut portion is fixed to a movable side energization rod, is included;
a fixed side cavity is formed between the fixed side contact back spot facing portion and the fixed side circular arc shaped power feeding portion, and a movable side cavity is formed between the movable side contact back spot facing portion and the movable side circular arc shaped power feeding portion;
a fixed side circular arc shaped first groove portion is formed on a termination end portion of the fixed side circular arc shaped coil portion of the fixed side coil electrode, a fixed side circular arc shaped second groove portion that is deeper than the depth of the fixed side circular arc shaped first groove portion is formed on a beginning end portion of the fixed side circular arc shaped coil portion of the fixed side coil electrode which sandwiches the fixed side slit, the fixed side circular arc shaped power feeding portion of the fixed side power feeding plate is arranged over the fixed side circular arc shaped first groove portion and the fixed side circular arc shaped second groove portion, the fixed side circular arc shaped power feeding portion of the fixed side power feeding plate is fixed to the fixed side circular arc shaped first groove portion, and a fixed side groove portion air gap is formed between the fixed side circular arc shaped power feeding portion of the fixed side power feeding plate and the fixed side circular arc shaped second groove portion; and
a movable side circular arc shaped first groove portion is formed on a termination end portion of the movable side circular arc shaped coil portion of the movable side coil electrode, a movable side circular arc shaped second groove portion that is deeper than the depth of the movable side circular arc shaped first groove portion is formed on a beginning end portion of the movable side circular arc shaped coil portion of the movable side coil electrode which sandwiches the movable side slit, the movable side circular arc shaped power feeding portion of the movable side power feeding plate is arranged over the movable side circular arc shaped first groove portion and the movable side circular arc shaped second groove portion, the movable side circular arc shaped power feeding portion of the movable side power feeding plate is fixed to the movable side circular arc shaped first groove portion, and a movable side groove portion air gap is formed between the movable side circular arc shaped power feeding portion of the movable side power feeding plate and the movable side circular arc shaped second groove portion.

9. The vacuum interrupter according to claim 8,
wherein when the outer diameter of the fixed side circular arc shaped power feeding portion of the fixed side power feeding plate is set to A, the outer diameter of the fixed side circular arc shaped first groove portion is set to H, the outer diameter of the fixed side circular arc shaped second groove portion is set to I, the outer diameter of the movable side circular arc shaped power feeding portion of the movable side power feeding plate is set to A, the outer diameter of the movable side circular arc shaped first groove portion is set to H, and the outer diameter of the movable side circular arc shaped second groove portion is set to I, the relationship of A≤H<I is established.

10. The vacuum interrupter according to claim 8,
wherein when the fixed side circular arc shaped power feeding portion of the fixed side power feeding plate is fixed to the fixed side circular arc shaped first groove portion of the fixed side circular arc shaped coil portion of the fixed side coil electrode, the fixed side circular arc shaped power feeding portion of the fixed side power feeding plate is set to a groove width that is to be out of contact with the fixed side circular arc shaped second groove portion of the fixed side circular arc shaped coil portion of the fixed side coil electrode; and when the movable side circular arc shaped power feeding portion of the movable side power feeding plate is fixed to the movable side circular arc shaped first groove portion of the movable side circular arc shaped coil portion of the movable side coil electrode, the movable side circular arc shaped power feeding portion of the movable side power feeding plate is set to a groove width that is to be out of contact with the movable side circular arc shaped second groove portion of the movable side circular arc shaped coil portion of the movable side coil electrode.

11. The vacuum interrupter according to claim 1,
wherein a fixed side power feeding plate spot facing portion is formed on the back surface of the fixed side disk portion of the fixed side power feeding plate, the fixed side disk portion of the fixed side reinforcing member is brought into contact with the fixed side power feeding plate spot facing portion, a movable side power feeding plate spot facing portion is formed on the back surface of the movable side disk portion of the movable side power feeding plate, and the movable side disk portion of the movable side reinforcing member is brought into contact with the movable side power feeding plate spot facing portion.

12. The vacuum interrupter according to claim 11,
wherein when the inner diameter of the fixed side power feeding plate spot facing portion of the fixed side power feeding plate is set to C, the outer diameter of the fixed side disk portion of the fixed side reinforcing member is set to D, the inner diameter of the movable side power feeding plate spot facing portion of the movable side power feeding plate is set to C, and the outer diameter of the movable side disk portion of the movable side reinforcing member is set to D, the relationship of DSC is established.

13. The vacuum interrupter according to claim 1,
wherein a circular fixed side through hole is formed in the fixed side disk portion of the fixed side power feeding plate, the fixed side disk portion of the fixed side reinforcing member is inserted through the fixed side through hole and is arranged on the fixed side contact back spot facing portion, a circular movable side through hole is formed in the movable side disk portion of the movable side power feeding plate, and the movable side disk portion of the movable side reinforcing member is inserted through the movable side through hole and is arranged on the movable side contact back spot facing portion.

14. The vacuum interrupter according to claim 13,
wherein when the inner diameter of the fixed side through hole of the fixed side power feeding plate is set to E, the outer diameter of the fixed side disk portion of the fixed side reinforcing member is set to D, the inner diameter of the movable side through hole of the movable side power feeding plate is set to E, and the outer diameter of the movable side disk portion of the movable side reinforcing member is set to D, the relationship of D≤E is established.

15. The vacuum interrupter according to claim 1,
wherein a fixed side power feeding plate slit that is led to one end of the fixed side circular arc shaped power feeding portion of the fixed side power feeding plate is formed in the fixed side disk portion of the fixed side power feeding plate, and a movable side power feeding plate slit that is led to one end of the movable side circular arc shaped power feeding portion of the movable side power feeding plate is formed in the movable side disk portion of the movable side power feeding plate.

16. (canceled)

17. The vacuum interrupter according to claim 9,
wherein when the fixed side circular arc shaped power feeding portion of the fixed side power feeding plate is fixed to the fixed side circular arc shaped first groove portion of the fixed side circular arc shaped coil portion of the fixed side coil electrode, the fixed side circular arc shaped power feeding portion of the fixed side power feeding plate is set to a groove width that is to be out of contact with the fixed side circular arc shaped second groove portion of the fixed side circular arc shaped coil portion of the fixed side coil electrode; and when the movable side circular arc shaped power feeding portion of the movable side power feeding plate is fixed to the movable side circular arc shaped first groove portion of the movable side circular arc shaped coil portion of the movable side coil electrode, the movable side circular arc shaped power feeding portion of the movable side power feeding plate is set to a groove width that is to be out of contact with the movable side circular arc shaped second groove portion of the movable side circular arc shaped coil portion of the movable side coil electrode.

18. The vacuum interrupter according to claim 4,
wherein a fixed side power feeding plate spot facing portion is formed on the back surface of the fixed side disk portion of the fixed side power feeding plate, the fixed side disk portion of the fixed side reinforcing member is brought into contact with the fixed side power feeding plate spot facing portion, a movable side power feeding plate spot facing portion is formed on the back surface of the movable side disk portion of the movable side power feeding plate, and the movable side disk portion of the movable side reinforcing member is brought into contact with the movable side power feeding plate spot facing portion.

19. The vacuum interrupter according to claim 7,
wherein a fixed side power feeding plate spot facing portion is formed on the back surface of the fixed side disk portion of the fixed side power feeding plate, the fixed side disk portion of the fixed side reinforcing member is brought into contact with the fixed side power feeding plate spot facing portion, a movable side power feeding plate spot facing portion is formed on the back surface of the movable side disk portion of the movable side power feeding plate, and the movable side disk portion of the movable side reinforcing member is brought into contact with the movable side power feeding plate spot facing portion.

20. The vacuum interrupter according to claim 4,
wherein a circular fixed side through hole is formed in the fixed side disk portion of the fixed side power feeding plate, the fixed side disk portion of the fixed side reinforcing member is inserted through the fixed side through hole and is arranged on the fixed side contact back spot facing portion, a circular movable side through hole is formed in the movable side disk portion of the movable side power feeding plate, and the movable side disk portion of the movable side reinforcing member is inserted through the movable side through hole and is arranged on the movable side contact back spot facing portion.

21. The vacuum interrupter according to claim 7,
wherein a circular fixed side through hole is formed in the fixed side disk portion of the fixed side power feeding plate, the fixed side disk portion of the fixed side reinforcing member is inserted through the fixed side through hole and is arranged on the fixed side contact back spot facing portion, a circular movable side through hole is formed in the movable side disk portion of the movable side power feeding plate, and the movable side disk portion of the movable side reinforcing member is inserted through the movable side through hole and is arranged on the movable side contact back spot facing portion.

22. The vacuum interrupter according to claim 4,
wherein a fixed side power feeding plate slit that is led to one end of the fixed side circular arc shaped power feeding portion of the fixed side power feeding plate is formed in the fixed side disk portion of the fixed side power feeding plate, and a movable side power feeding plate slit that is led to one end of the movable side circular arc shaped power feeding portion of the movable side power feeding plate is formed in the movable side disk portion of the movable side power feeding plate.

23. The vacuum interrupter according to claim 7,
wherein a fixed side power feeding plate slit that is led to one end of the fixed side circular arc shaped power feeding portion of the fixed side power feeding plate is formed in the fixed side disk portion of the fixed side power feeding plate, and a movable side power feeding plate slit that is led to one end of the movable side circular arc shaped power feeding portion of the movable side power feeding plate is formed in the movable side disk portion of the movable side power feeding plate.
